(19) United States
(12) Patent Application Publication
(10) Pub. No.: US 2013/0080346 A1
(43) Pub. Date: Mar. 28, 2013

(54) Apparatus and Methods for an Application Process and Data Analysis

(71) Applicants: Craig Powell, Providence, RI (US); Jeffrey Alderson, Dorchester, MA (US); Samantha Mansfield, Arlington, MA (US); Hank Van Zile, Arlington, MA (US)

(72) Inventors: Craig Powell, Providence, RI (US); Jeffrey Alderson, Dorchester, MA (US); Samantha Mansfield, Arlington, MA (US); Hank Van Zile, Arlington, MA (US)

(73) Assignee: ConnectEdu, Inc., Boston, MA (US)

(21) Appl. No.: 13/618,015

(22) Filed: Sep. 14, 2012

Related U.S. Application Data
(63) Continuation of application No. 11/406,065, filed on Apr. 18, 2006.
(60) Provisional application No. 60/672,443, filed on Apr. 18, 2005.

(51) Int. Cl. G06Q 50/20

(52) U.S. Cl. CPC G06Q 50/2053
USPC 705/327

(57) ABSTRACT

One aspect of the invention relates to a method of simplifying an application process. The method includes a series of steps that can be performed in any particular order. The steps include dividing: the application process into a plurality of sub-processes, arranging a portion of the plurality of sub-processes in response to a scheme, collecting user profile data in response to a plurality of queries, the queries selectively presented to the user in response to a branching logical hierarchy, generating a report in response to the profile data; and targeting information to a desired demographic of users in response to user profile data correlations.

### FIELD OF THE INVENTION

The invention relates to the management of an application process incorporating targeted marketing and content delivery features. In particular, the invention relates to techniques and devices suitable for simplifying the process of applying for a position with an entity an managing enrollment that enable collection and utilization of demographic data.

This application claims priority to U.S. Provisional Patent Application 60/672,443 filed on Apr. 1, 2005, the disclosure of which is herein incorporated by reference in its entirety.

### BACKGROUND OF THE INVENTION

The college application process is a complex and time sensitive endeavor with an unpredictable outcome. Furthermore, as the number of applicants far exceeds the number of class positions at many educational institutions, the application and selection process is also extremely competitive. Notwithstanding these hurdles, the costs of education continue to spiral upwards with each passing year. On a parallel track from the admission officer perspective, student transfers and wasted marketing efforts often make enrollment management expensive and inefficient.

As a result, the process of applying to educational institutions is often a time consuming and stressful process for prospective applicants and their families. Unfortunately, given the above-identified factors,, in combination with the complexity of the student loan process, many applicants feel overwhelmed and poorly informed about the application and selection process. Accordingly, a need therefore exists for improvements in the process of applying to educational institutions. In particular, improvements that offer time savings and reduce applicant anxiety are highly desirable. Additionally, as the process of applying for a position with a particular entity generates large volumes of information, methods for using that information are also of value.

The methods disclosed herein provide a comprehensive, interactive technology solution for high schools, counselors, students, parents, community colleges, employers, advisers, college admissions officers and others engaged in the college preparation, search, application, enrollment management, and financial aid process.

The college preparation, selection, application, financial aid and admission process is overwhelming for a number of specific reasons. First, the process is staged in time over multiple years. Thus, the college preparation process could start in elementary school and conclude before or after high school graduation As a result, individual applicants, their families, and other participants in the process (college counselors, colleges/universities, student loan and 529 plan providers, and sales representatives) need to take the long view. However, the fast-paced nature of life and the time constraints on all users make this especially difficult. Second, the steps of the application process are often esoteric and not readily discernible by a given applicant. As a result, people miss deadlines, submit non-compliant applications, or otherwise prejudice themselves by not knowing when and how to take appropriate action. Thirdly, the delivery of the information often comes too late or in a form that is difficult for a given applicant or user to understand or respond to. Finally, from the college admission, college counselor, and loan provider perspective, the huge number of users going through the process presents significant data processing challenges.

The Applicants have discovered that these and other factors make the preparation, application, financing, selection, and admission processes unmanageable for many applicants. Similarly, admission officers are overloaded with paper and operating in a highly inefficient system that struggles to admit the right applicants. Accordingly, the techniques disclosed herein are designed to address these specific factors and simplify the college application and admission processes. Additionally, in conjunction with theses techniques aspects of the invention also provide enhanced content delivery to applicants and other users.

The methods disclosed herein allow users to select between the over 3,700 college profiles, featuring every two and four-year college in the United States, Canada and the US Territories. Academic institution profiles provide users with the ability to easily search and navigate information about a college/university at-a-glance as well as providing detailed information on Admissions, Cost & Financial Aid, Academics, Student Voices, Student Body, Campus Life and Athletics. Additionally, the methods disclosed herein provide colleges with the ability to integrate their applications and application process for seamless completion by the users. Colleges also gain the ability to audit and analyze their admission and rejection histories using the techniques disclosed herein.

The methods disclosed herein provide users with a plurality of functions and tools in combination with a robust suite of content resources to ensure successful, timely completion of each student's educational institution application plan. From an implementation standpoint, in one embodiment all data elements (users, profiles, resources, forms, plans, etc., etc.) in the system are defined as objects suitable for processing in a software environment, for example, a database. Users are able to search, prospect and sort/compare against other users, profiles or objects. Objects are also able to sort/compare against users and other subjects. Data stored and associated with a user, object or resource are transferable to pre-populate other resources, objects or forms. Additionally, the implementation of the method identifies correlating predecessors and dependents between each object and user profile to inform the format, elements and characteristics of each object as the user experiences the object in one embodiment.

The following summary describes certain aspects and embodiments of the invention. It does not encompass every embodiment, and should not be construed as limiting the invention.

In part, the invention relates to a software platform for addressing the college placement process. The college placement platform connects a plurality of users, including, but not limited to counselors, students, parents, teachers, letter of recommendation authors, high school administrators in an access controlled community environment. The methods empower college counselors while simultaneously ensuring that students have a customized application process and college selection solution. Similarly, the methods disclosed herein streamline and/or eliminate administrative tasks so that counselors, parents and applicants are comfortable with the application process and achieve their admission objectives.

In one aspect, the invention relates to a method of simplifying an educational institutional application process. The method includes a plurality of steps. In part, the method includes dividing the educational institutional application process into a plurality of sub-processes, and arranging a portion of the plurality of sub-processes in response to a scheme. In some embodiments, the scheme is a calendar or a logical arrangement of steps. The method also includes the steps of collecting user profile data in response to a plurality of queries, the queries selectively presented to the user in response to a branching logical hierarchy; and generating a report in response to the profile data.

In one embodiment of this aspect, the report is indicative of a trend of interest to the educational institution or an action item the user must satisfy to advance an aspect of the educational institution application process. Additionally, in another embodiment, the method further includes the step of alerting the user to critical milestones. In another embodiment, the method provides access to vendor services in response to a user inquiry. The method further includes the step of delivering targeted content to the user in response to user profile data in one embodiment. Alternatively, in yet another embodiment the invention further includes the steps of screening users and restricting user access to a class of users defined by a relationship to participating partner firms. The report is a financial aid application form in one embodiment. However, in another embodiment the report is selected from the group that includes a scholarship application, a 529-application form, a student loan application, a list of potential colleges, and/or a college application plan.

In another aspect, the invention relates to a method of supporting a user's application process to an educational institution. The method includes a plurality of steps. In particular, the method includes developing a profile for the user through a sequence of questions, the questions presented through a graphic user interface and presenting a set of possible answers to each question such that selection of a given answer triggers the next question in the sequence. The method also includes correlating the answers to each question to an admission profile for the educational institution; selecting educational institutions for the user to apply to based on likelihood of success; and instructing the user with at least one of a strategy or a action item reminder to improve their likelihood of application acceptance.

In one embodiment, the relationship between the questions and answers is based on a set of college application process rules and/or historical user profile data. The educational institution can be a financial aid institution. In addition, the financial aid institution can be a federal agency.

In general, in one aspect, the invention relates to a method of targeting a user participating in an application process. The method includes the steps of generating a plurality application process objects, each having an object profile; comparing the profiles of different objects to determine correlations between objects; determining a demographic profile about one or more users in response to correlations between objects and historical object profiles; and delivering content to a user having the demographic profile.

In one embodiment of this aspect, the application process is a college selection process, Additionally, in another embodiment a partner company pays for delivering content to the user having the demographic profile, The correlation of this aspect can be determined using a filtering technique. Alternatively, in one embodiment the partner company is a student loan provider.

In another aspect, the invention relates to a method of selecting applicants for admission to an academic institution. The method includes the steps of collecting retention data and admission profile data for a plurality of admitted applicants; correlating admission profile data to determine which applicants remain at the academic institution and graduate to identify a graduating applicant profile; and admitting students having an admission profile to the academic institution, wherein the admission profile is substantially correlated with the graduating applicant profile. In one embodiment, the method further includes the step of directing marketing materials to prospective applicants that substantial match one or more criteria associated with a graduating applicant profile. The method can also include the step of establishing a dialogue with prospective applicants that substantial match one or more criteria associated with a graduating applicant profile.

In yet another aspect, the invention relates to a enrollment management system adapted for selecting students for admission to an academic institution. The system includes a database, and a user interface in electronic communication with the database adapted for searching for prospective applicants. The database includes applicant profile information and applicant retention information. The system also includes a user interface for prospective applicants to communicate with admissions officers and a data analysis module for correlating applicant retention information and applicant profile information to identify prospective applicants that have a reduced likelihood of transferring from the academic institution after admission. The applicant retention information can include transfer statistics for one or more admitted students. The prospective applicants that have a reduced likelihood of transferring from the academic institution can be evaluated in comparison to an overall applicant pool for a given admission cycle.

In still another aspect, the invention relates to a method of recommending an academic institution to a prospective applicant. The method includes the steps of collecting admission data about the applicant, the admission data comprising applicant criteria; calculating a GPA for the applicant; assigning weights to the criteria; scoring academic institutions in response to the weighted criteria; and generating a tiered list of academic institutions, the tiered list comprising academic institution listed in descending order of goodness of fit with the prospective applicant.

In still yet another aspect, the invention relates a method of applying for a student loan. The method includes the steps of collecting student identification information using a graphic user interface, the graphic interface associated with a first server; determining financial need in response to a financial aid interview; selecting one of a plurality of lending institutions from a display screen; populating an automated loan application form associated with the selected lending institution using the identification information, the automated loan application associated with a second server, querying the student user for any missing student loan application information; and submitting a completed student loan application to the selected lending institution. In one embodiment, the student user is pre-qualified for a student loan in response to the user completing a portion of a college application. The plurality of lending institutions can be displayed to a user in response to a demographic parameter specified by at least one lending institution. In addition, a security identifier can be associated with the second server is used to establish a secure channel between the first and second servers.

Prior to discussing some aspects of the academic institution enrollment management and student applicant institution selection embodiments of the invention in detail, an introduction to some of the characteristic criteria used in some embodiments of the invention may prove useful. However, the scope of the terms discussed herein is not intended to be limiting, but rather to clarify their usage and incorporate the broadest meaning of the terms as known to those of ordinary skill in the art.

Grade Point Average (GPA). GPA can refer to the normalized average of academic grades based upon available transcript data that has been input to the system. The normalized GPA can be calculated based on the grade received for each course and the number of credits that the course represents. Alternative grading systems and GPA scales that are not based on a maximum of 4.0 can be scaled to the equivalent of a 4.0 scale. If transcript data is unavailable, the student's self-reported GPA and GPA scale can be used to calculate a normalized GPA. If the student has not self-reported a GPA and GPA scale, GPA may not be used as valid criteria for the recommendation.

Test Scores. Test scores can refer to the maximum score received by a student in each of four test categories. SAT Reasoning, SAT Math, SAT Writing and ACT Composite. However, other test scores may be used. If a student has taken the same test multiple times, only the highest score from each category is used. In the event a student has taken both the SAT and the ACT, the test score for which the college reports a 50% acceptance range may be used. In the event the college reports both an SAT and ACT range and the student has taken both the SAT and the ACT, the student SAT score can be used. If the student has not self-reported either an SAT or ACT score, test scores may not be used as valid criteria for the recommendation.

Setting. Setting can refer to the general description of the surrounding area of a college. Allowed values for setting include, but are not limited to: Urban, Suburban, and Rural. The student is allowed to choose one-to-many values as their preference for setting. If the student has not self-reported a setting preference, setting may not be used as a valid criterion for the recommendation.

Size. Size can refer to the total undergraduate enrollment for a given college. Allowed ranges for size preference include, hut are not limited to: fewer than 1,000 students, 1,000 to 5,000 students, 5,000 to 10,000 students, 10,000 to 20,000 students and more than 20,000 students. The student is allowed to choose one-to-many ranges as their preference for size. If the student has not self-reported a size preference, size may not be used as a valid criterion for the recommendation.

Location. Location can refer to a list of states where a college is located. A student is allowed to choose any number of states to create a location preference. If the student has not self-reported a location preference, location may not be used as a valid criterion for the recommendation.

Sport. Sport can refer to a list of sports and associated levels available at a college. A student is allowed to choose any number of sports, and for each sport choose a set of corresponding levels, to create a sport preference. It the student has not self-reported a sport preference, sport may not be used as a valid criterion for the recommendation.

Type. Type can refer to the ability of a college to receive public funds. Allowed values for type include, but are not hunted to, Public, Private and Proprietary. A student is allowed to choose any number of types to create a type preference. If the student has not self-reported a type preference, type will not be used as a valid criterion for the recommendation.

Area of Study. Area of Study can refer to the general categories of minors that are available at a given college. A student is allowed to choose any number of majors or general categories to create an area of study preference. If the student chooses a specific major, the parent general category may be added to their list of general categories to create the area of study preference. If the student has not self-reported art area of study preference, area of study may not be used as a valid criterion for the recommendation.

Although the term college, university, and academic institution are used throughout, the use of any of these terms in meant to include the scope of the other and not otherwise limit the invention to a particular type of post high school academic institution.

An advantage of one aspect of the invention is the ability to utilize historical data to predict admissions and financial aid success for students based on the performance of the school's students historically.

Another advantage of one aspect of the invention is that users receive specific opportunities and content within an application process in response to their profile without affirmatively requesting them.

Yet another advantage of one aspect of the invention is that academic institutions can develop a substantially paperless admission program that offers improved efficiency by targeting those students that are not likely to transfer and that are likely to perform well academically.

The details of one or more embodiments of the invention are set forth in the accompanying drawings and the description below. Other features, objects, and advantages of the invention will be apparent from the description, drawings and examples, and from the claims.

### BRIEF DESCRIPTION OF THE DRAWINGS

FIG. 1 is a schematic drawing of a system suitable for performing the methods disclosed herein according to an illustrative embodiment of the invention;

FIG. 2 is a schematic drawing of a workflow depicting steps and components according to an illustrative embodiment of the invention;

FIGS. 3A-3C are schematic drawings of example process flows of the data analysis and application process steps according to an illustrative embodiment of the invention;

FIG. 4A is a schematic drawing of a related network according to an illustrative embodiment of the invention;

FIG. 4B is an exemplary graphic interface for accessing features associated with a relational network according to an illustrative embodiment of the invention;

FIG. 5A is a schematic drawing depicting some of the sub-processes relating to an overall educational institution application plan according to an illustrative embodiment of the invention;

FIG. 5B is an exemplary graphic interface for accessing the application and resources depicted in FIG, 5A according to an illustrative embodiment of the invention

FIGS. 6A-6J are exemplary graphic interfaces to aspects of an application process according to an illustrative embodiment of the invention;

FIG. 7 is a schematic drawing depicting an overview of a college admission office student enrollment management system according to an illustrative embodiment of the invention;

FIGS. 8A-8D are exemplary graphic interfaces for interacting with or receiving information from portions of the enrollment management system depicted in FIG. 7 according to an illustrative embodiment of the invention;

FIG. 9A is a schematic drawing of a workflow relating to a student loan application process according to an illustrative embodiment of the invention; and

FIGS. 9B-9D are exemplary graphic interfaces for interacting with a student loan provider according to an illustrative embodiment of the invention.

### DETAILED DESCRIPTION

The following description refers to the accompanying drawings that illustrate certain embodiments of the invention. Other embodiments are possible and modifications may be made to the embodiments without departing from the spirit and scope of the invention. Therefore, the following detailed description is not meant to limit the present invention. Rather, the scope of the present invention is defined by the appended claims.

In part, aspects of the invention relate to a comprehensive, interactive technology solution for a broad class of users engaged in the college preparation, search, application and financial aid process. However, the techniques disclosed herein are extendible to any application process for a position of interest. One aspect of the invention divides the application process into a plurality of sub-processes and milestones. In turn, these sub-processes and milestones are organized in time in response to a calendar scheme based upon the timelines associated with the overall application process. Thus, interactive college/university application plans are one aspect of the invention.

Furthermore, in order to simplify the process, action items and reminders are delivered in manageable portions sufficiently ahead of time to reduce anxiety and ensure compliance with the requirements of the application process. Any conceivable component of the application process can integrate into a framework that allows the applicant/user to automatically receive the information in a manageable format with an associated timetable and recommendations for taking the necessary action using the methods disclosed herein.

In conjunction with streamlining an application process, another aspect of the invention relates to analyzing and filtering profile data associated with the users of the methods disclosed herein to develop specific demographic populations for the purposes of targeting particular users. Specifically, establishing demographic populations of users facilitates targeted content delivery (advertisements, college profiles, scholarships, etc. etc.) to the users for particular purposes (to aid the application process, sell goods and services to the users, establish product branding, etc. etc.).

Moreover, the process of locating certain classes of users and sending them targeted advertisements are services that many vendors will pay to use and access. Since suitable users for the methods disclosed herein can include, but are not limited to high schools, counselors, students, parents, advisors, colleges, advertising agencies, sales representatives, student loan providers, and other relevant parties, the business methods disclosed herein are of interest to many service providers and sales personnel.

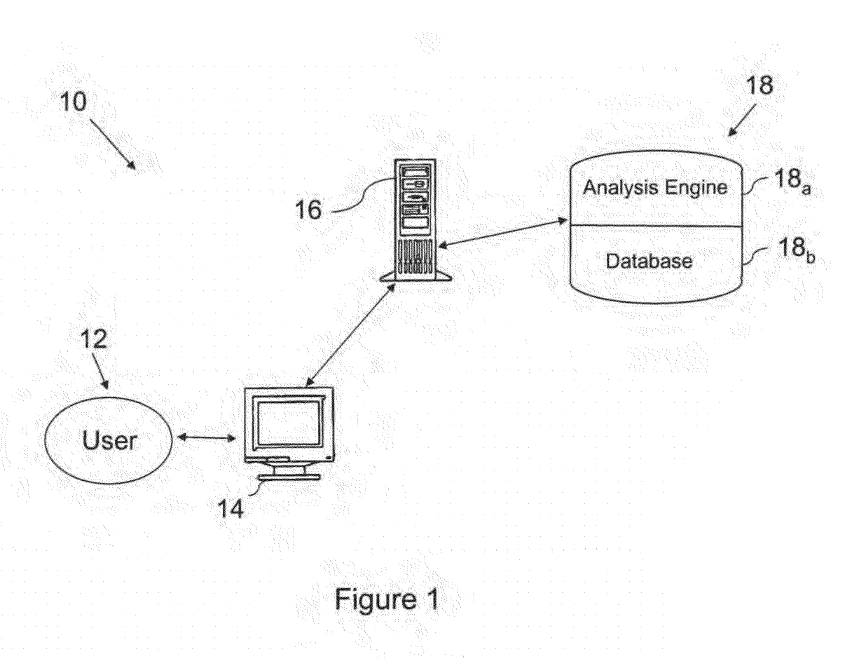

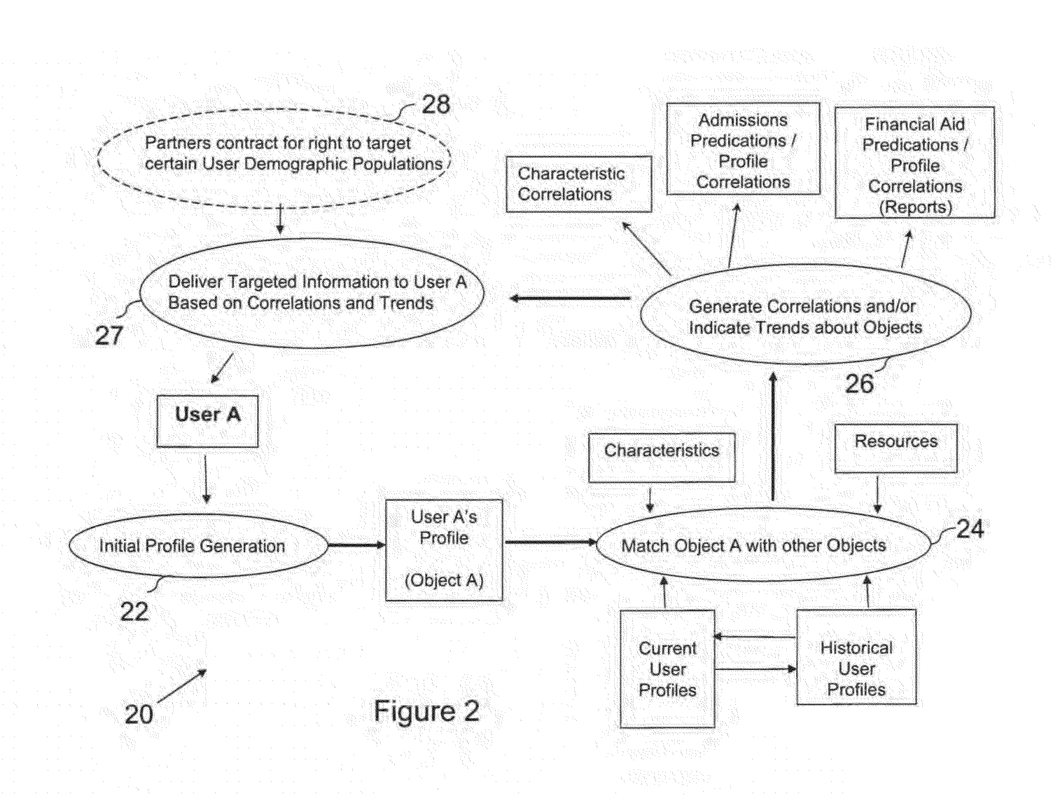

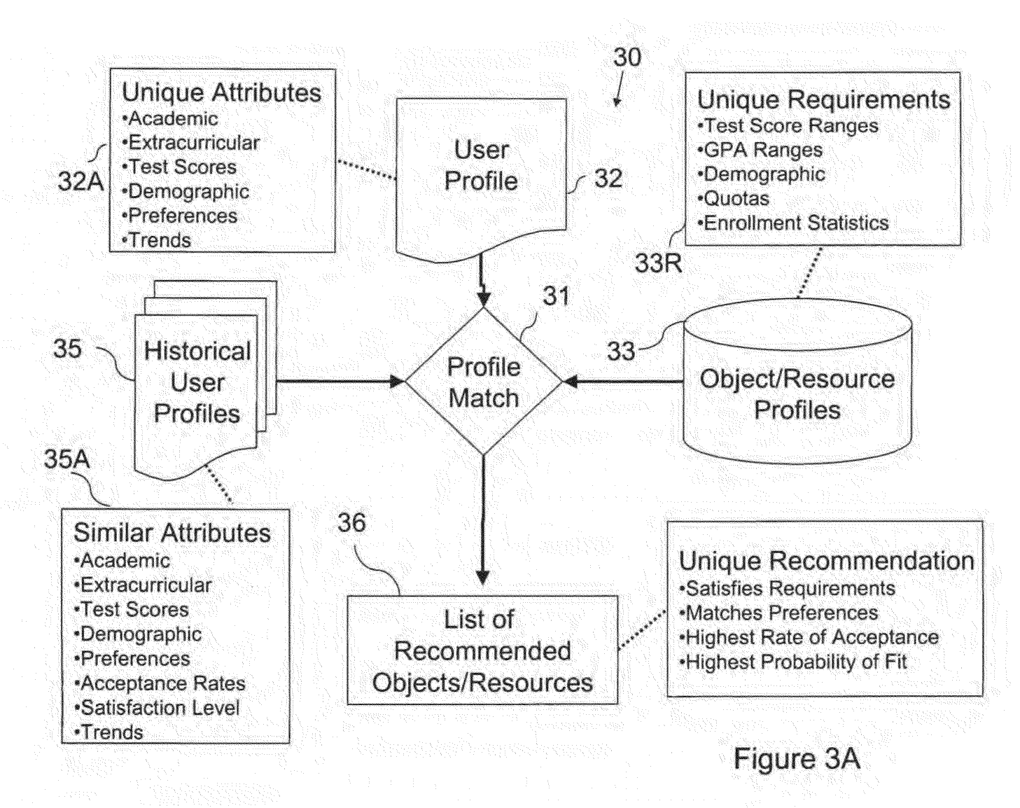

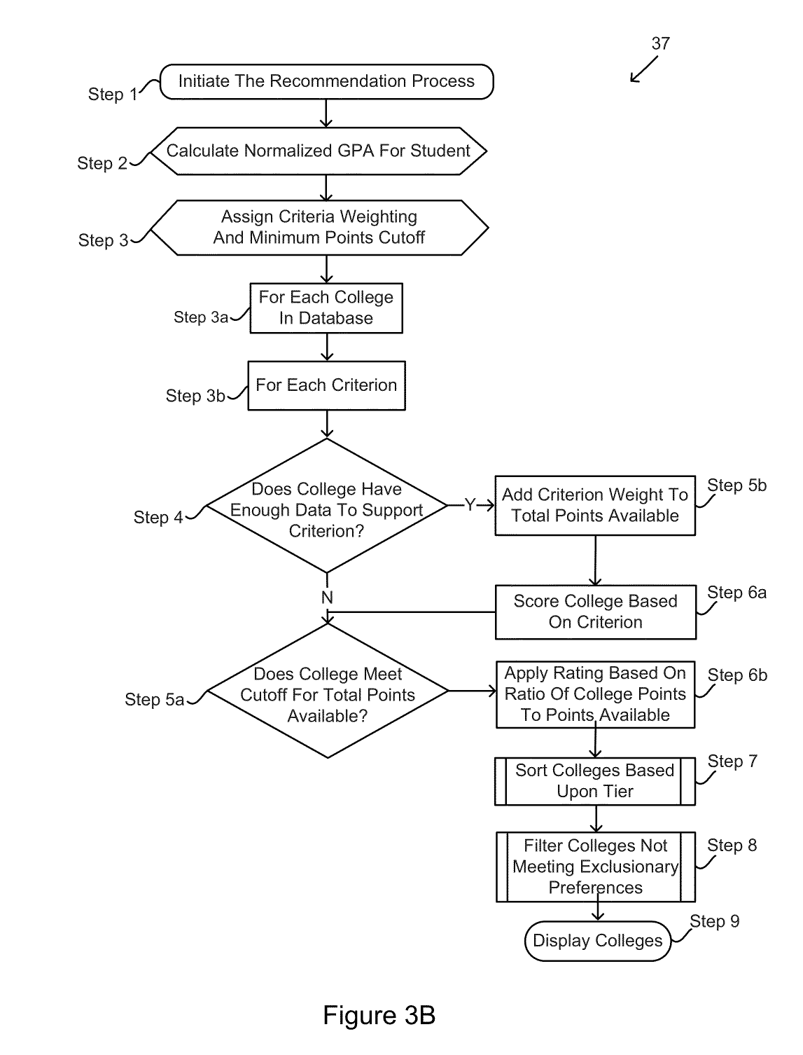

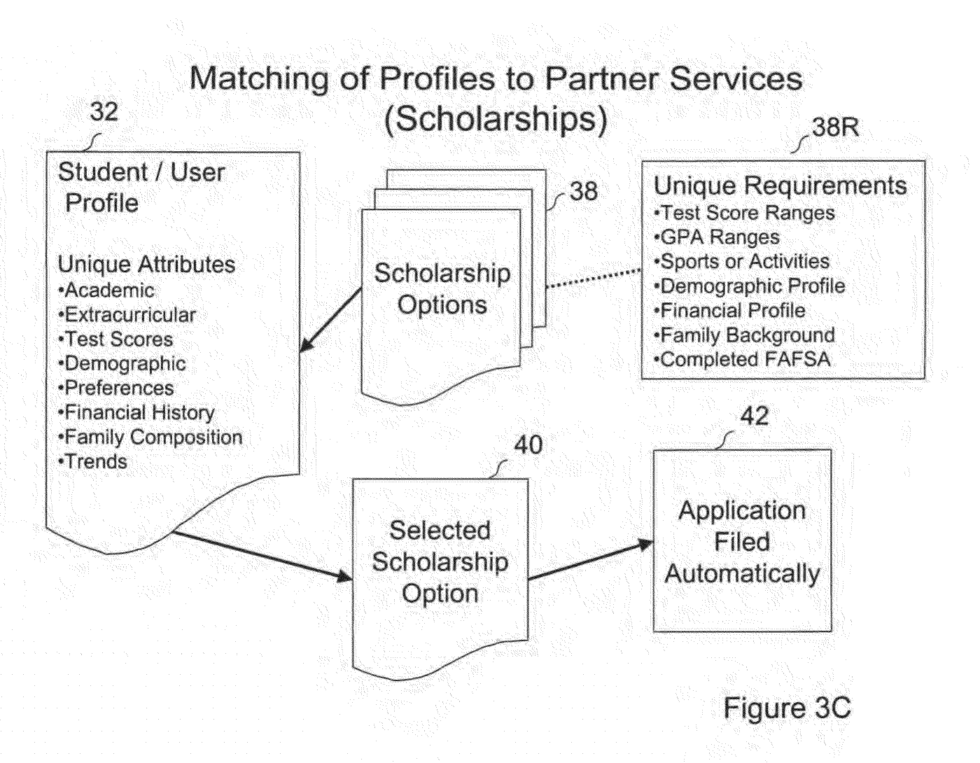

By integrating historic user and education institution data with data derived by user selections and decisions, profile matching across the entire population of past and present users is possible. As a result, correlations between user profiles allows for, but is not limited to: college selection, applicant selection, oversight of applicants, targeted delivery of any content to users based on profile matching, and other objectives as disclosed herein. However, prior to considering those features in more detail, an exemplary implementation of the technology is depicted in FIG. 1. Additional details relating to profile matching are discussed below with regard to FIGS. 2, 3A and 3B.

FIG. 1 depicts a general overview of data delivery system 10 incorporating some of the components used in a software implementation of an exemplary method of the invention. A user 12 typically accesses and transmits the relevant data and targeted information via a web browser 14 that is adapted for accessing an application server 16. In one embodiment, the web browser accesses one or more profiles to connect resources, tools, content, applications, scholarships, colleges and user community events based on correlating characteristics in a given software object's profile and a user's profile.

The server 16 includes software and hardware components necessary for running Active Server Pages (ASP) based technologies as known to those of ordinary skill in the art. In addition, the server includes operating systems, modules, protocols, engines and interfaces as necessary to perform the methods and data analysis disclosed herein. In particular, the server includes an application management/data analysis software implementation 18 of one or more of the methods disclosed herein such that a user may access and interface with the software implementation 18 via the web browser 14.

In an exemplary embodiment, an application management/data analysis software implementation 18 includes a plurality of software modules such as, for example, an analysis engine 18a and a database 18b. The database 18b is suitable for storing historical data and new data created in response to the users 12 of the system 10. While the analysis engine 18a is adapted for at least one of transmitting, searching, indexing, targeting, prospecting, sorting, comparing, and correlating the data stored in the database 18b or otherwise accessible via the software implementation 18 and the users 12. The database can include, but is not limited to objects, profiles, user preferences, user/school criteria, calendar scheme, questions/answers, hierarchical logic, resources, rules, derived/evolved data, historical data. Student Information Systems (SIS) data, Customer Relationship Management (CRM) data, articulation agreement data, college enrollment management data, retention data, Online Analytical Processing (OLAP) data, and other suitable data and information.

One exemplary software implementation 18 is capable of processing all components of a given application process, such as a college selection, application, financing process, and enrollment management as objects. Thus, high school students, parents, counselors, sales representatives, student loan providers, college admission officers, a standardized test, a particular university, a particular product, or virtually any other real world entity are described as objects within the software implementation 18. In turn, these objects can be stored in the database 18b in a suitable format and analyzed by the data analysis component 18a. Although FIG. 1 depicts an overview of an aspect of the system of the invention, additional detail relating to the process flow of different embodiments of the invention appears in FIG. 2 and FIGS. 3A-3C.

FIG. 2 depicts an exemplary process flow 20 for different method steps and data types of an embodiment of the invention. The exemplary process flow 20 centers on a particular user, User A, of the system depicted at FIG. 1. Specifically, the process flow describes generating an initial user profile or multiple user profiles (object(s)) (Step 22); and comparing or matching object profiles (Step 24). Given a collection of objects having profiles, the process flow 20 generates correlations and or indicates trends regarding the objects associated with different profiles (Step 26); and targets specific users with content in response to the correlations or trends (Step 27). Various inputs contribute to this process flow 20, such as for example, current profiles, historical data, resources and object characteristics. In addition, the process flow shows the optional step of contrasting with vendor/partner firms to delivery specific content to targeted users (Step 28). Having introduced some of the elements of the process flow 20 at a high level, it is useful to consider some of the steps in more detail.

As discussed above, the user is typically treated as an object for data processing and searching purposes, but can be any real world entity having an interest in the application process, enrollment management process or other users. The process flow 20 shows the interaction of the users with the methods of the invention and reveals the advantages possible with the claimed approach. Although the process flow 20 can be examined or initiated at any point in the flow, it makes sense to start with the process of initially generating a profile (Step 22) for the user or any other system object.

Each object may have a profile associated with it as appropriate. For example, User A, perhaps a high school student applying to college, can generate a profile (Step 22) and store it as an object, Object A, in the database 18a. The student's profile may include standardized test scores, GPA, extracurricular activities, gender, level of financial aid need, colleges/universities of interest to the student, geographic areas of interest to the student, and other parameters relevant to the process of applying to an educational institution. However, a profile for a given student may also include other characteristic or preference information such as favorite band, music genres of interest, whether they own a car, their parents' income level, where they like to shop, and other parameters as may be of interest to a marketing or sales representative. Similarly, a college admissions officer or a college/university may have a profile that incorporates some of the same or different parameters and characteristics.

The data analysis/data mining aspects of the invention in some implementations facilitate subtle changes in and evolution of the profiles. Specifically, a user's interaction with the system can further define that user's profile. In one embodiment, the profile includes certain preferences and criteria. These profile changes populate the database in real-time or based on a schedule. Thus, if a user spends four hours reading certain messages boards, two hours working with a particular counselor, one hour looking at a particular school, these actions will inform his or her profile. Thus, a user's interaction with the methods disclosed herein is tracked and can be associated with that user to serve as a basis for data mining and additional object correlations. As such, the demographic correlations possible using the techniques of the invention can be highly user specific.

Since users set up individual profiles, there is a great variety in what constitutes an individual profile. Each object profile may define information elements that are accessible to, or stored for, the associated object, and other objects. Thus, a high school student (object 1) may access the profile of a particular college (object 2). In turn, the particular college profile (object 2), as administered by a college admission professional, may access any unrestricted portions of the high school student's (object 1) profile as appropriate. In one implementation, a series of questions and answers initially populate the profile for a particular object. The questions and answers can be a set sequence based on object presentation rules. For example, in one embodiment, the initial question sequence of: login, password, name, address, phone number and gender is the same for all students when initially establishing their profile.

Additionally, a logical branching hierarchy is also suitable to determine the question and answer sequence presented to a particular user. Thus, if a user responds to a particular set of questions with a particular string of answers, the data analysis engine may deviate from a hardwired list of questions and present tailored questions in response to the answer string. The significance of the answer string can be determined by comparing historical data and the data stored for other users that answered the first battery of questions analogously to the user. However, other mechanism for presenting specific questions and sets of possible answers, such as flow charting, fuzzy logic, applicant screening and other techniques as appropriate to generate a profile that tracks various user characteristics of interest. These question and answer presentation techniques can also be used to populate forms, such as a financial aid loan or student loan application.

Thus, the methods disclosed herein provide form completion tools that branch users through forms based on providing them questions that are informal and response to the users profile and previously provided answers. In addition, users possess the ability to create on-line forms and applications by selecting from a pick list of potential questions or profile characteristics to roll-up into the creation of documents, form or applications.

Returning to FIG. 2, having generated one or more profiles, the process flow 20 matches objects having profile elements in common (Step 22) and determines correlations (Step 24) between the user profiles, other users and components/objects in the application process by attempting to match portions of object profiles in response to some data analysis criteria. Thus, User A's profile may indicate a certain SAT score, a preference for pre-veterinary programs, and an interest in schools in the rural south. In response, the step of matching object profiles (Step 22) may generate a report that lists objects such as colleges, universities, scholarships, college counselors, hotels, restaurants, and high school classmates having profiles that share some or all of those three profile parameters. Alternatively, the data analysis component of the invention may also deliver content or other objects to User A based on what other users, with profiles that are similar to User A, are interested in, but would not naturally follow from User A's profile.

The process of matching profiles (Step 22) can be performed using various statistical processes such as for example the Kalman filter, point allocation matching, scoring, curve fitting, and/or other correlation and matching algorithms known in the art. Matching filters are generated over time using enrollment management information that is collected over a period of years. A filter can include criteria that determine whether a student is likely to be admitted by a particular college and/or whether the college wants to admit a particular student. As a college begins to understand what constitutes a successful admissions decision based on student academic performance and retention, the system's filters will automatically identify student profiles that are most often successful. Conversely, a student applicant benefits from the historical data associated with the type of applicant that a particular college accepts. As an example, from the college admission perspective discussed in more detail below, one filter can bee based on the constraint that that many state universities find that retention rates are inversely related to the student's distance from their home. For the student applicant that is seeking admission, a suitable filter may be based on historical data that indicates that if the student is from State A and applying to College B, that there is an increased likelihood that they will be admitted. Additionally, the matching correlation process typically uses current user profile data, historical user data, and specific user characteristics. In addition, to matching objects having specific profiles, the methods disclosed herein are adapted to direct specific resources (books, tasks, tutoring services, college application plans, electronic forms, student loan providers, 529 plans and others) to a given user based on their profile.

Again referring to FIG. 2, once a set of objects having matching profile elements is determined, additional data analysis occurs to correlate the profiles and identify trends (Step 26). Thus, if certain admission patterns emerge for particular colleges, potential applicants receive reports from the data analysis and reporting functions of the claimed invention. Therefore, if female applicants that played a varsity sport and scored above a 1200 on the SAT are likely to be admitted to a school XYZ, a similar applicant (User B) with a lower SAT score has an idea that she needs to receive additional tutoring on the verbal portion to attain a score of 1200 or above. More specifically, the techniques disclosed herein allow for data analysis and profile matching such that delivery of the profile of a suitable verbal SAT tutor to User B occurs automatically in response to User B's profile and her interest in school XYZ. Emailing, populating a personal college plan web page resident on the application server 16 with a tutor link, or otherwise calling User B's attention to the suitable verbal SAT tutor represents a form of targeted information delivery (Step 27) within the scope of the invention.

However, the process of delivering information to users need not always be entirely academic in nature. Since all of the objects in the database can be interrelated by profile, there are many avenues to market to potential students and/or develop certain brand identity among a given demographic population. Matching of profiles shows trends and rankings among different objects. Thus, object clustering in response to specific search criteria informs a sales representative, service provider or other user about a particular demographic user set.

For example, a need for cell phone service is a characteristic that may be important to a user. If that user is interested in attending school in New York City, the user's other characteristics, such as their interest in music, how far away their home state is from NYC, and their other profile elements can enable one or more cell phone companies to generate a target list of user leads. (Step 28). Thus, the cell phone company can pay a subscription fee, a fee per demographic list, a fee to deliver content to a particular user, or other compensation schemes as appropriate. Alternatively, the student could query all of the cell phone companies in New York City profiled using the methods and systems disclosed herein. The student's access to the method may be by various payment systems or as part of their parent's employee benefits package. Collaborating with employee benefit providers represents one business method embodiment of the invention.

Additional, details relating to the process of matching profiles are depicted in FIGS. 3A-3C. FIG. 3A shows another process flow 30 depicting an aspect of the invention. In particular, the process flow 30 shows the profile-matching step (Step 31) in additional detail. The methods disclosed herein enable varying degrees of predictive modeling with regard to the application process. This occurs, in part, by creating, tracking and/or storing college applicant profiles (generally, user profiles 32). For example, the profiles 32 may include various attributes 32A. Exemplary user attributes include academic, non-academic, financial, process, trends, preferences, demographic information, enrollment status and college preferences.

As discussed above, additional objects and resources 33, such as colleges, specific college programs, scholarships, financial aid process, and others are accessible to the process flow and the steps of the methods disclosed herein. In turn, these objects and resources have specific requirements 33R such as for example, test score ranges, GPA ranges, demographic requirements, quotas, enrollment statistics, and other suitable requirements and/or attributes. In one embodiment, in order to be candidate for a particular college or financial aid resource (object 33), a particular user's profile 32 must satisfy, to some extent, the requirements 33R of the particular object/resource 33. Thus, the match (Step 31) between user profile 32 and object requirements 33R allows for a preliminary list of potential objects, such as a college selection listing, for the user to review.

However, the Applicants have discovered a methodology for further enhancing the quality of the results delivered in response to a user query or a targeted delivery in response to a user profile. The enhancement arises from the inclusion of historic user profiles 35 having associated historic user profile attributes 35A. Historic use profiles can be proprietary data relating to the application and admission data for a set of applicants and colleges. In turn, historic user profiles develop over time as users select, apply to, and receive acceptances from educational institutions using the methods described herein. This allows for a database that can evolve over time. Thus, as genetic algorithms enhance programming, the changes in the applicant pool over time and adjustments in the policies and politics of the schools are captured such that future users benefit from enhanced data analysis. As a result, by performing a second level of profile matching using historical user profiles 35, additional trends and recommendations are discernable using data analysis and correlation techniques.

One exemplary method of the invention compares current student profiles to historic student profiles. As a next step, correlating positive characteristics between profiles in order to predict likelihood of admission, allocation of financial aid, and distribution of financial aid types is possible. In turn, this correlation process uses positively correlated characteristics to inform application, interview and admissions strategies or reports.

Additional details relating to a method for making recommendations based upon certain student profile parameters, such as specific criteria, are shown in FIG. 3B. As part of the recommendation process 37 depicted in FIG. 3B, various criteria are considered, certain weights are allocated among the criteria, and after assessing a recommendation based on the allocated weighting parameters, a display of the recommended options is presented to the student or other user of the system. In one embodiment, the criteria include, but are not limited to at least one of grade point average (GPA), test scores, setting, size, location, sport, type and area of study.

In one embodiment, the method 37 depicted in FIG. 3B is encoded as part of a recommendation engine, module or algorithm that provides recommendations once a user has outlined certain preferences, criteria, and their academic history. Based on some or all of those parameters, a recommendation of those academic institutions that are best matched to them is generated. For example, as a student or other system user identifies particular preferences and inputs a set of criteria, a data set is built up for that individual. In turn, this data set can be processed as raw data or plotted as a curve. In one embodiment, the shape of the curve arises from a function with different weights given to certain preferences and criteria. Thus, in one implementation of this function, the criteria of SAT and GPA are heavily weighted with the other preferences and criteria contributing to the shape of the resultant curve. The user data sets and curves are scaled such that they be compared to other curves and datasets associated with particular schools. Through a process of data comparison, such as Kalman filtering, the error, the standard deviation, and other statistical factors can be used to match school data with user data. This process of matching applicant data with the best fitting college data emulates the decision making process used by most academic institutions.

In one embodiment, the data used to make an admission decision, for a college admission officer, or a college selection decision, for a potential application, is weighted based on a points system. Additional details relating to this point system are discussed below. In general, points are allocated to each preference parameter and criteria with SAT and GPA receiving most of the points. If certain data points are missing, the point system facilitates a curve fit based on the available data such that a recommendation, most often a tiered list of recommendations, can be provided to a system user. This approach of providing tailored rank ordered results represents a significant improvement over a simple report that lists all possible candidate schools in alphabetical order, with no indication of an applicants likelihood of admission. Since the recommended colleges are presented in a tiered format, the end user can review candidate schools or in the case of an enrollment manager a list of candidate students based on goodness of fit. In one embodiment, a predetermined number of the first 15 or 20 schools, in each tier, is presented by tier from best fit to worst fit. In this embodiment, the user is typically given the option to see other tiers of schools, beyond the 15 or 20 listed, by clicking a link or icon on a suitable interface screen.

In order to understand the process in more detail, it is useful to consider the exemplary recommendation process 37 depicted in FIG. 3B. In general, the method attempts to list academic institutions, based on points scored relative to the criteria that form part of the admission profile of a particular applicant. The score of the academic institution with respect to the student's admission profile determines how the tiered list is assembled.

The first step is to initiate the recommendation process (Step 1). Typically, this step is initiated in response to a student, a guidance counselor, a parent, an admission officer, a lender, or other user of the system seeking to match a student with a particular profile to a particular institution. For example, accessing the choose college interface screen discussed below would use data input from a system user in combination with other data to generate a tiered list of candidate colleges. Given the significant impact that GPA plays in the college admission process, the next step is to calculate a normalized GPA for the student (Step 2). As data about a particular user is analyzed to match the user with the best fitting subset of academic institutions, user data must be weighted based on the realities of the college selection process, i.e. test scores and GPA may have a larger impact on goodness fit than the geographic preferences of a user. As a result, the next step, which can include two more substeps is to assign criteria weightings and minimum points cutoff (Step 3). This assignment of criteria weighting and minimum points cutoff can be performed for each college in database (Step 3a) and for each user criterion (Step 3b). Thus, if a college has a cut off for one or more of the student's criteria, the college may or may not appear on the tiered list as a function of the student's criteria.

At this point in the process 37, a determination is made as to whether there is enough data in the system to support a match for a given college based on the criterion specified (Step 4). This means that if the college does not meet a particular criteria that is important to the student user, the colleges score will go down. The next step is to add criterion weight to total points available (Step 5a). A determination is then made as to whether the college meets a cutoff for total points available (Step 5b). The college is then scored based on Applicant criterion (Step 6a). The next step is to apply a rating based on ratio of college points available (Step 6b). As a result, it is possible to sort colleges based upon a tier ranking model (Step 7). Furthermore, it is possible to filter colleges that do not meet exclusionary preferences (Step 8). Thus, if an applicant only cares about colleges in the southern United States, colleges outside of this geographic area, that are otherwise good fits, may not be displayed. As a result, of these decisions and the impact of the weights and user criteria, the system displays a tiered list of academic institutions (Step 9).

The weighting process discussed above is a method suitable for execution as an algorithm in a software module by which criteria and preference parameters are allocated points in certain embodiments to affect matching schools and students. Specific details relating to exemplary weight allocations for the GPA, test scores, setting, size, location, sport, type, and college is given as a percent match based on available criteria. If all criteria are available, this is based upon a total of 100 points. If any criterion is not available, its points are deducted from the total, and the percent match is calculated based on the remaining points. For example, if GPA were omitted, only 60 points would be available, and the percent would be calculated as a ratio of matching points divided by available points. However, other point allocations amounts can be used, for example the total number of points could be set at 1,000 with GPA counted for 400 points, or a higher or lower number of points based on changes to admission conditions. In addition, in one embodiment, in the event that a college profile does not have the data required to support a matching recommendation on a given criterion, that college will receive 0% of the possible points allowed for that criterion.

As part of the weight assignment to GPA, the total number of points available for the GPA criterion is 49 out of 100 in one embodiment. A normalized academic standard GPA of 3.0 can be assumed. In some embodiments, two factors can be used to allocate the number of available points for GPA out of the maximum point total, typically 100. These two factors are the normalized GPA of the student, and the college reported value of % of applicants accepted whose GPA was greater than 3.0.

For each college, the intersection of the two factors will result in a percentage of the possible points for GPA. This formula takes into account the fact that most grade point averages vary between 2.0 and 4.0, and as a GPA approaches 2.0 the weighting value of GPA for a recommendation approaches zero.
If student's GPA is below 3.0:

$$Lim {\vert}_{Δ -> 0} \vert \frac{( 1 - Coll \% ) \cdot 100}{{e}^{Δ}} = ( 1 - Coll \% ) \cdot 100$$

$$Lim {\vert}_{Δ -> ∞} \vert \frac{( 1 - Coll \% ) \cdot 100}{{e}^{Δ}} = 0$$

$$Lim {\vert}_{Δ -> 2} \vert \frac{( 1 - Coll \% ) \cdot 100}{{e}^{Δ}} = \frac{( 1 - Coll \% ) \cdot 100}{7.39}$$

Δ−difference between the student's GPA and the academic standard GPA
Coll %=the % students having greater than a 3.0 GPA

In one embodiment, the total number of points available for the test scores criterion is 30. However, this point assignment can change as appropriate. A determination is made whether to use the ACT or SAT scores for a student based on the definition provided for test scores for a particular academic institution or user profile. A determination is made whether the college has reported on the old (2-section) or the new (3-section) SAT based upon how many of the three sections have range values. If the college is reporting on the old SAT, each section (Math/Verbal) represents 50% of the points available for the test scores criterion. If the college is reporting on the new SAT, each section (Math/Writing/Reasoning) represents 33.3% of the points available for the test scores criterion.

For each SAT section or ACT, a determination is made for the percentage of points given for that section based on the students score in that section and the range of scores that the college reports. If the student's score falls within the college range, the resulting percentage of points can be calculated on a linear scale with the low end of the range giving 25% and the high end of the range giving 75% of the possible points for that section. If the student's score is less than the low end of the range, but within 5%, 20% of the possible points for that section are given. If the student's score is less than the low end minus 5%, but greater than the low end minus 10%, 10% of the possible points for that section are given. If the student's score is less than the low end minus 10%, 0% of the possible points for that section are given. If the student's score is greater than the high end of the range, but within 5%, 80% of the possible points for that section are given. If the student's score is greater than the high end plus 5%, but less than the high end plus 10%, 90% of the possible points for that section are given. If the student's score is greater than the high end plus 10%, 100% of the possible points for that section are given.

In one example, the total number of points available for the setting criterion is 5. If the student's setting preference is “Urban” and the college's setting is Urban, the college will receive 100% of the points available for setting. If the student's setting preference is Suburban, the college will receive 50% of the points available for setting, Similarly, if the student's setting preference is Rural, the college will receive 0% of the points available for setting.

If the student's setting preference is Rural and the college's setting is Urban, the college will receive 0% of the points available for setting. If the student's setting preference is Suburban the college will receive 50% of the points available for setting, if the student's setting preference is Rural and the college is Rural, the college will receive 100% of the points available for setting.

The total number of points available for the Size criterion is 5. If the college enrollment falls within any range in the student's size preference, the college will receive 100% of the points available for size. If the college enrollment falls within 10% outside any range in the student's size preference, the college will receive 90% of the points available for size. If the college enrollment falls within 10 to 20% outside any range in the student's size preference, the college will receive 75% of the points available for size. If the college enrollment falls within 20 to 25% outside any range in the student's size preference, the college will receive 50% of the points available for size. If the college enrollment falls greater than 25% outside any range in the student's size preference, the college will receive 0% of the points available for size.

The total number of points available for the Location criterion is 8. If the college is located in a state that is present in the list of states in the student's location preference, the college will receive 100% of the points available for location. If the college is located “one state away” (as defined based on a variable geographic rule or table) from any state that is present in the list of states in the student's location preference, the college will receive 50% of the points available for location.

The total number of points available for the Sport criterion is 5. If the college has a sport available at the level that matches any sport and associated level in the student's sport preference, that college will receive 100% of the points available for sport. If the college has a sport available that matches any sport in the student's sport preference, but not the associated level for any sport, that college will receive 50% of the points available for sport. If the college does not have a sport available that matches any sport in the student's sport preference, that college will receive 0% of the points available for sport.

The total number of points available for the Type criterion is 2. If the student's type preference is Public and the college's type is Public the college will receive 100% of the points available for type. If the student's type preference is Private the college will receive 50% of the points available for type. If the student's type preference is Proprietary the college will receive 0% of the points available for type. If the student's type preference is Private and the college's type is Public the college will receive 75% of the points available for type. If the student's type preference is Private the college will receive 100% of the points available for type. If the student's type preference is Proprietary the college will receive 0% of the points available for type. If the student's type preference is Proprietary and the college's type is Public the college will receive 0% of the points available for type. If the student's type preference is Private the college will receive 0% of the points available for type. If the student's type preference is Proprietary the college will receive 100% of the points available for type.

The total number of points available for the Area of Study criterion is 5. If the college has any of the specific general categories or majors listed in the student's area of study preference, the college will receive 100% of the points available for area of study. If the college has a similar major, the college will receive 75% of the points available for area of study. If the college does not have any specific or similar majors or general categories that appear on the student's area of study preference, the college will receive 0% of the points available for area of study. The recommendation algorithm will display a table of results organized in order of Score that each college receives. If multiple colleges receive the same score, the colleges receiving the same score will be presented alphabetically.

In response to performing steps of the recommendation process, information is displayed to the user that initiated the process, Typically, the output that results from the recommendation method discussed above is the official name of the college will be displayed and linked to the College Profile for that college. Directly in front of the college name will be an icon that, when clicked, will add the college to the student's college list. The city and state of each college can also be displayed immediately following the name of the college. In one particular embodiment, each college row will have a table cell that indicates the total number of points received by a college for each criterion. If the maximum number of points were received, the number of points will be listed in bold. Points will be displayed in the format XX.X. According to this embodiment, for each college the cumulative score out of the scaled 100% of points available will be displayed in the format XX.X%. Additionally, for each college recommend, a checkbox can be displayed to indicate the presence of that college on the college list for access by the student, parents, and other approved users.

The results of the two tiered profile analysis approach disclosed herein can be presented to the user in the form of a report 36 identifying recommended objects/resources based upon the user's profile. A specific example of the object/profile matching and wizard functionality of an embodiment is depicted in FIG. 3C.

FIG. 3C shows an exemplary matching process for a partner service provider. The term partner describes a user of the methods that provides or seeks to provide a good or service to an educational institution applicant. Specifically, the partner illustrated in FIG. 3C is a scholarship offeror, however, the example is extendible to any suitable partner. A user subscribing to the methods disclosed herein may have a profile 32 that is suited to a particular scholarship. The set of all possible scholarship options 38 is a collection of objects having differing unique requirements 38R. The matching and correlations techniques introduced above would compare the user's profile 32 with the requirements 38R to generate a selected scholarship option 40. This option 40 would include the one or more scholarships that match the user's profile.

The methods disclosed herein also incorporate wizards, form population schemes, and electronic delivery mechanisms. As a result, once a particular scholarship offered by a given partner has been identified, the integration of the different aspects of the invention allows the scholarship application to be completed and filed automatically (Step 42) based upon the user profile data resident on the application server 16. The ability for aspects of the college application process to be prepared automatically using existing profile and user data represents a further advantage of the invention.

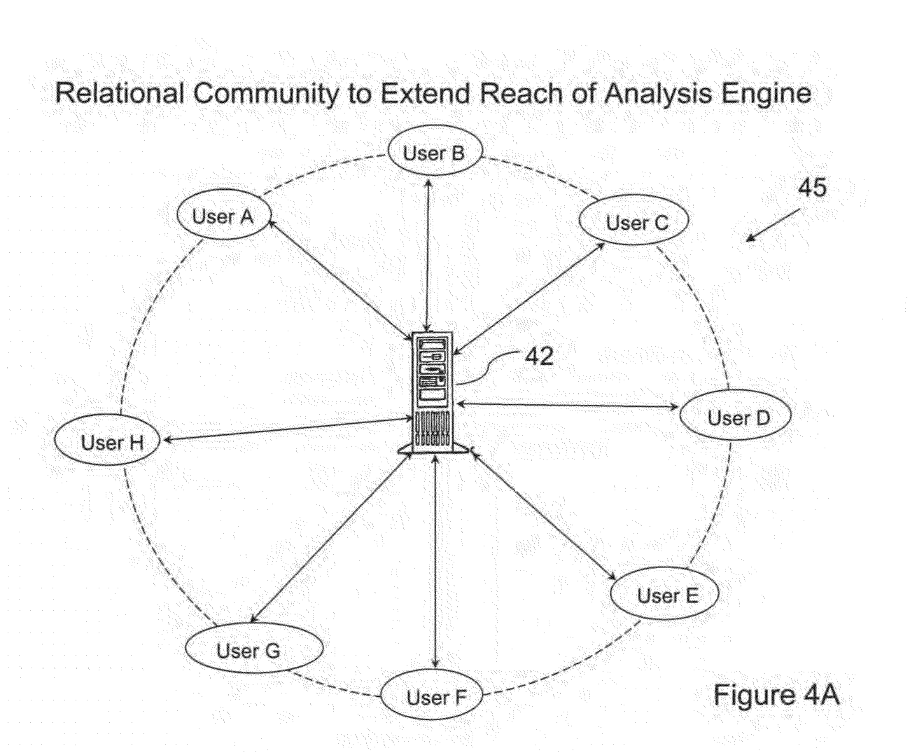

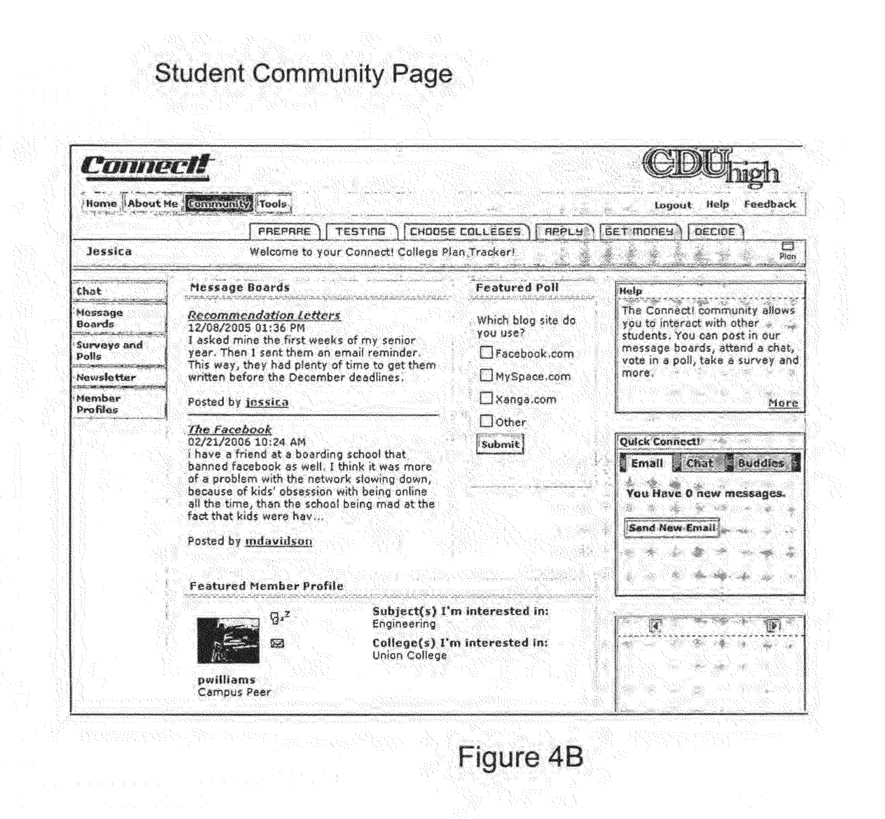

In addition, the invention is extendible to a broad community of users via the relational network 45 shown in FIG. 4A. Users A-H represents a community of members that can exchange information among themselves using the methods disclosed herein to further improve an application process. Although FIG. 4A depicts a central applicant server 42 tying the users together, any topological network configuration is possible for the network 45. The relational network of users represents another aspect of the invention. Although many of the users may be high school students and/or their parents, the users can also be college students that previously used the methods disclosed herein to select a school. Guidance counselors, colleges, partner companies, loan providers, or any other entity or person involved in the application, selection, financing, and admission process or otherwise interested in the resultant demographic data can be members of the relational network. An exemplary graphic user interface showing a student access page for the relational network and community of users is shown in FIG. 4B for an embodiment of the invention.

In one exemplary embodiment the network is relational such that individual members receive access levels because they, individually or as a group, satisfy a certain criteria. As a result, multiple relational networks are possible with varying degrees of overlap as a function of different users having different levels of access to other objects and other relational networks.

For bar example, a bank may offer its employees access to the methods disclosed herein as part of an employee sponsored benefit program. As result, the majority of the high school users would be the children of bank employees. Accordingly, their access to the network would be conditioned on their parent's employment status. Similar, the bank could regulate which other partner companies have access to the network. Therefore, if a particular bank was also a student loan provider, the invention allows for them to prescribe rules by which members of the community receive targeted lending advertisements for the partner bank's services. As a result, when a partner company sponsors the methods disclosed herein, certain benefits are possible on the employee retention and direct marketing front. However, there are many other benefits associated with the relational network paradigm disclosed herein.

FIG. 4A shows a depiction of the relational network 45 at a high-level. However, as the network is relational, the potential exists for all of the users to form a large interlinked web of individuals and entities for the exchange of information, guidance, and varied perspectives regarding an application process. The network also extends the power of the object/profile matching and data analysis approaches described above.

Specifically, the inclusion of a relational network of user's allows the analytic and search features relating to a particular set of users to extend to a broader class of users. The ability to extend the analytic power of the population to non-participating users or users participating a different level or part in the overall process allows for efficiencies and an increase in net utility for existing users. The relational network enables a vibrant interactive community environment for users to interact with one-another. Feedback, recommendations, and most importantly, a broader set of profiles and objects for data analysis and profile comparison all follow from the inclusion of a relational network.

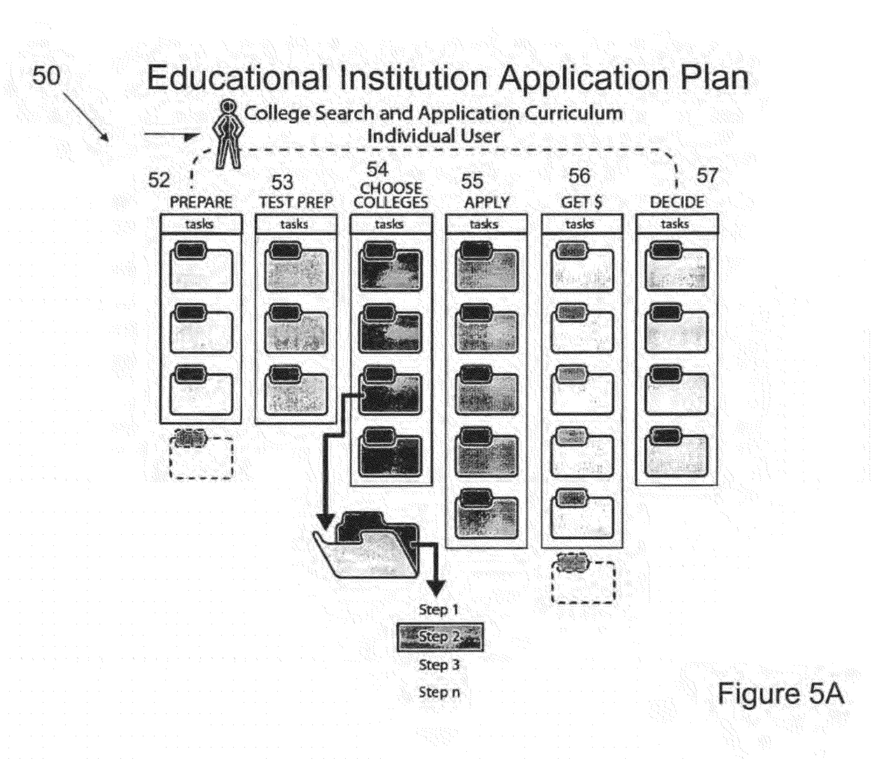

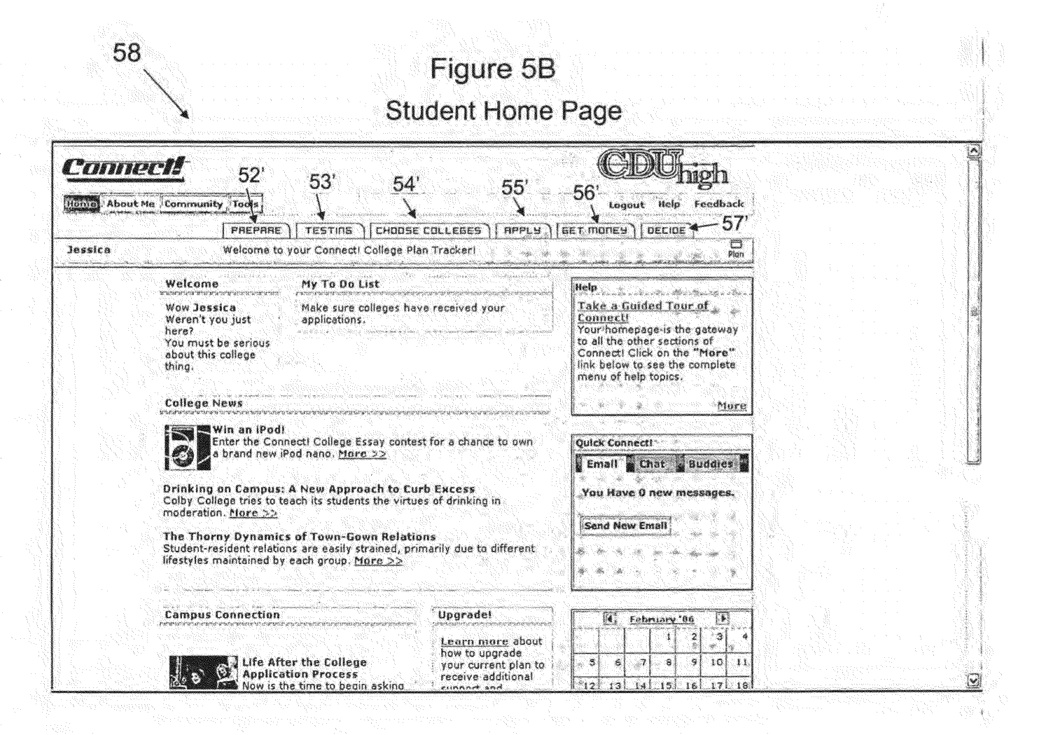

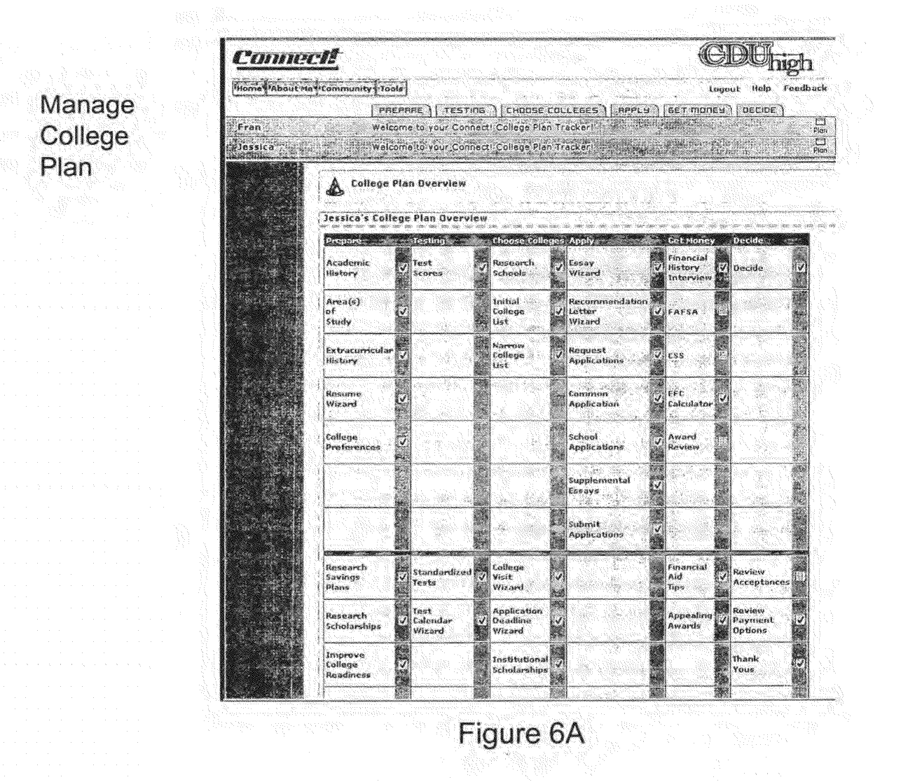

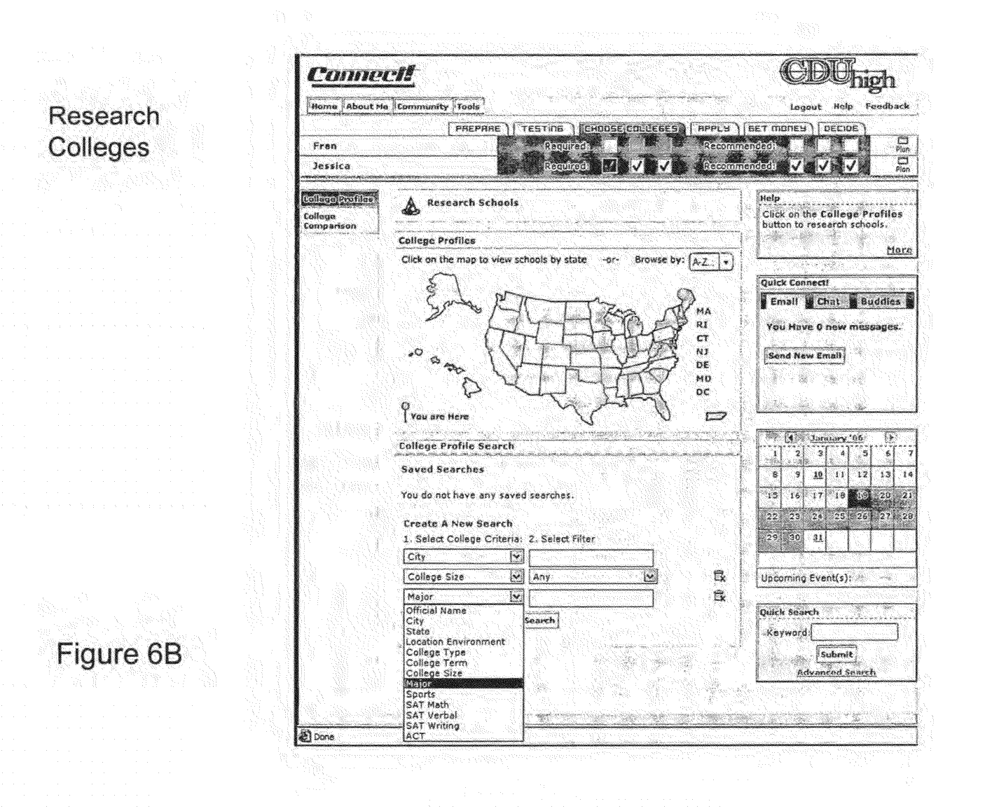

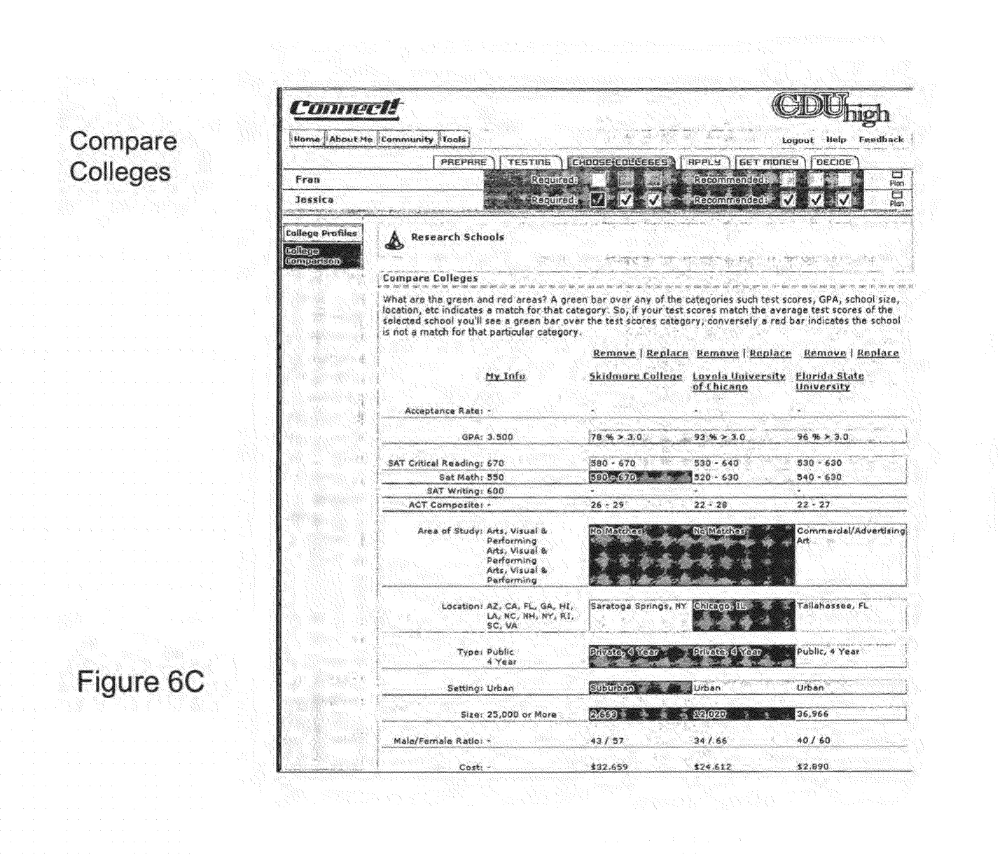

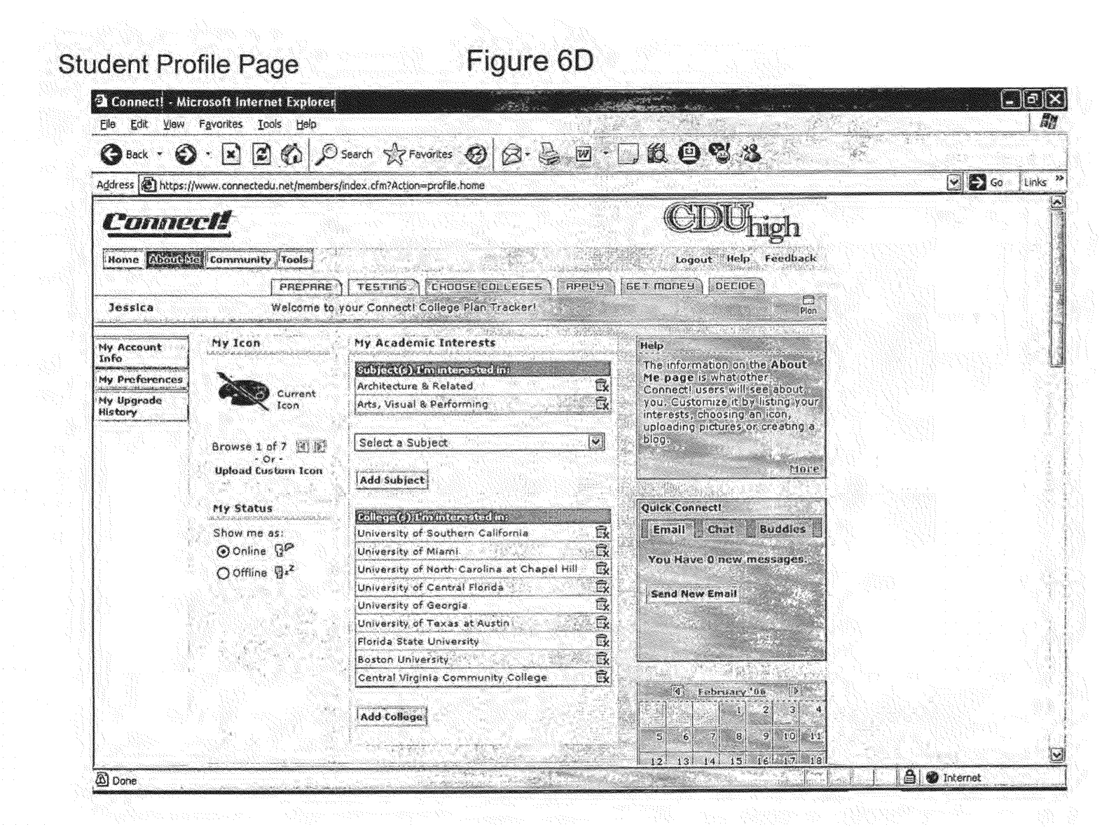

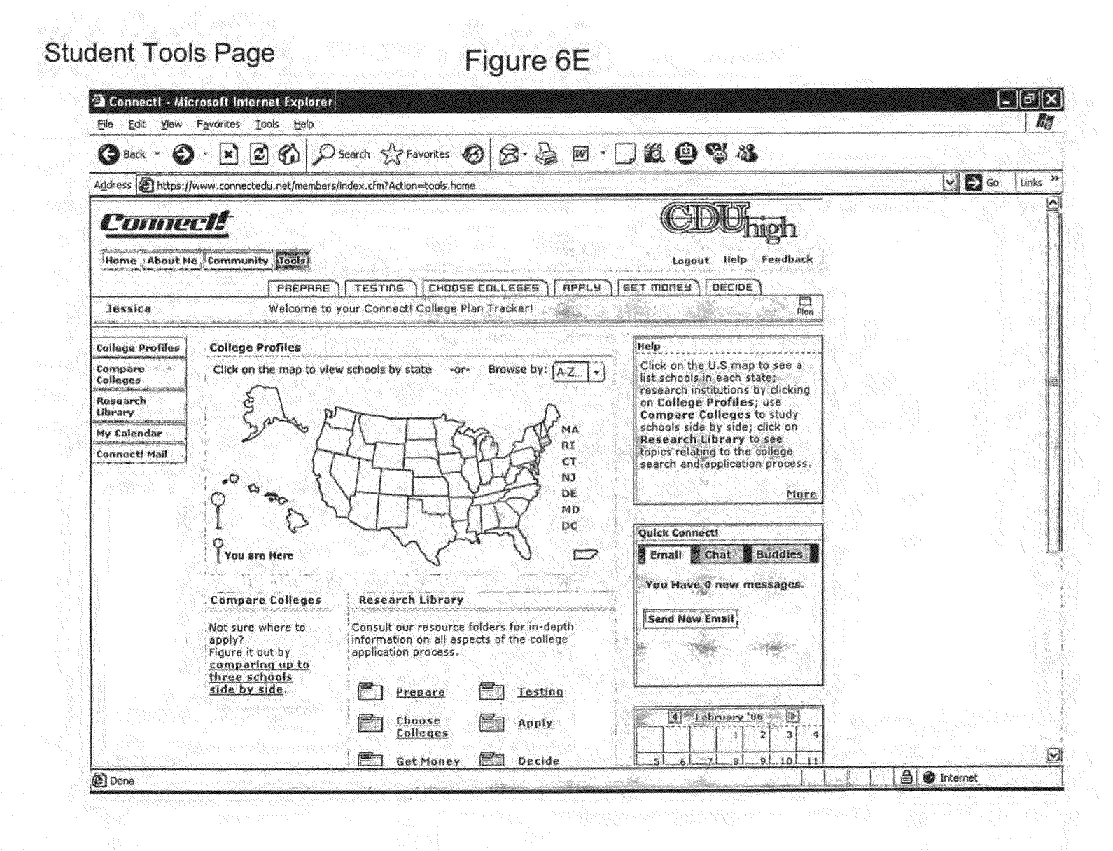

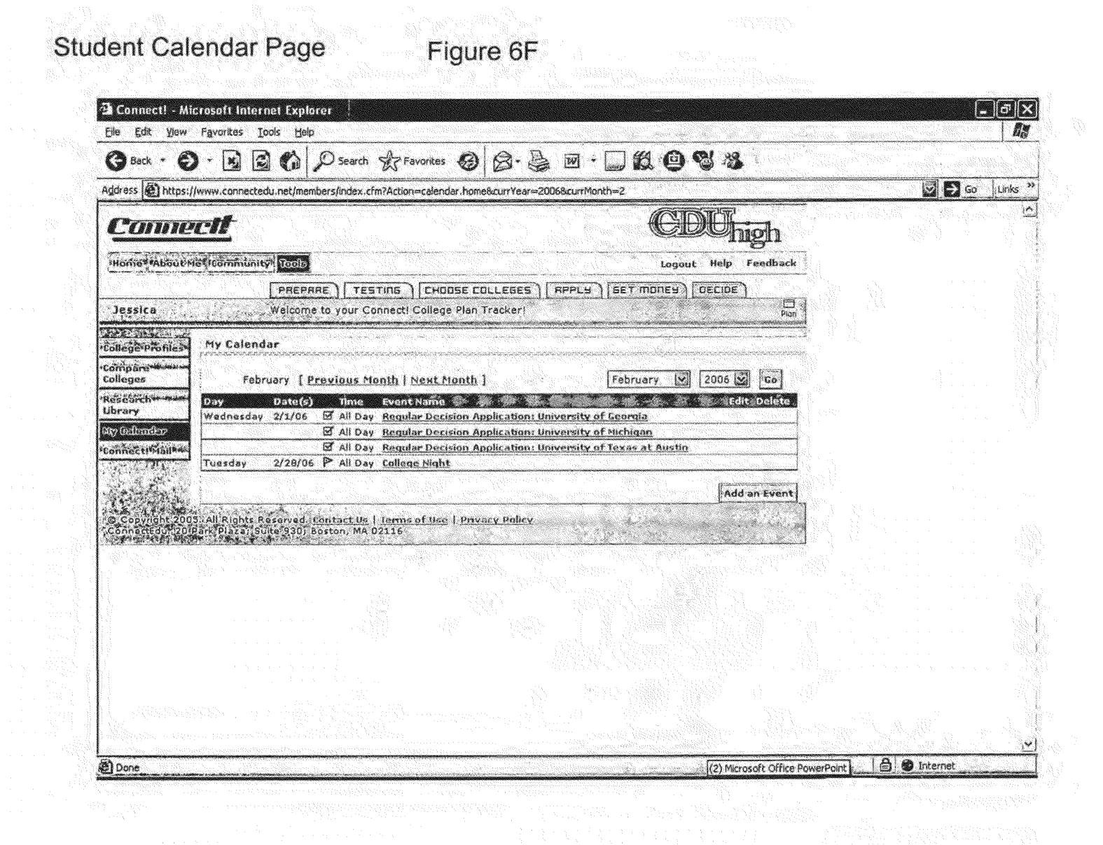

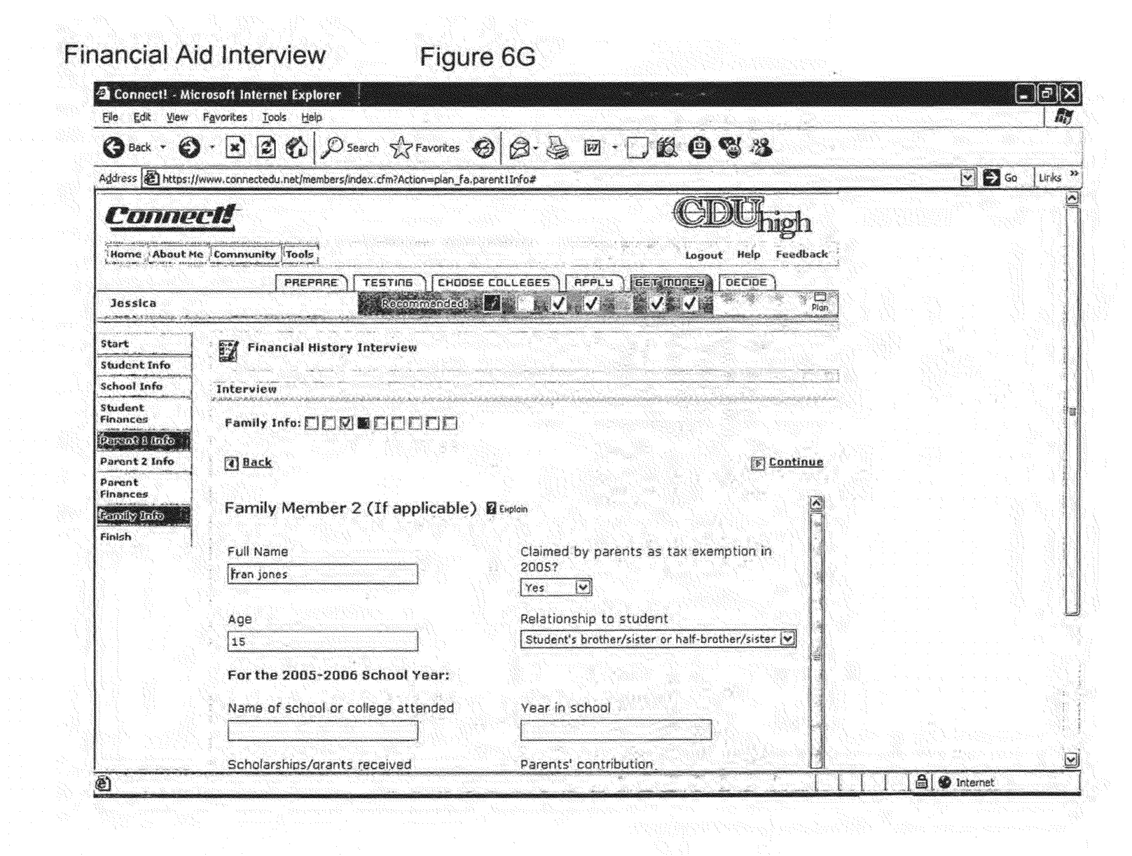

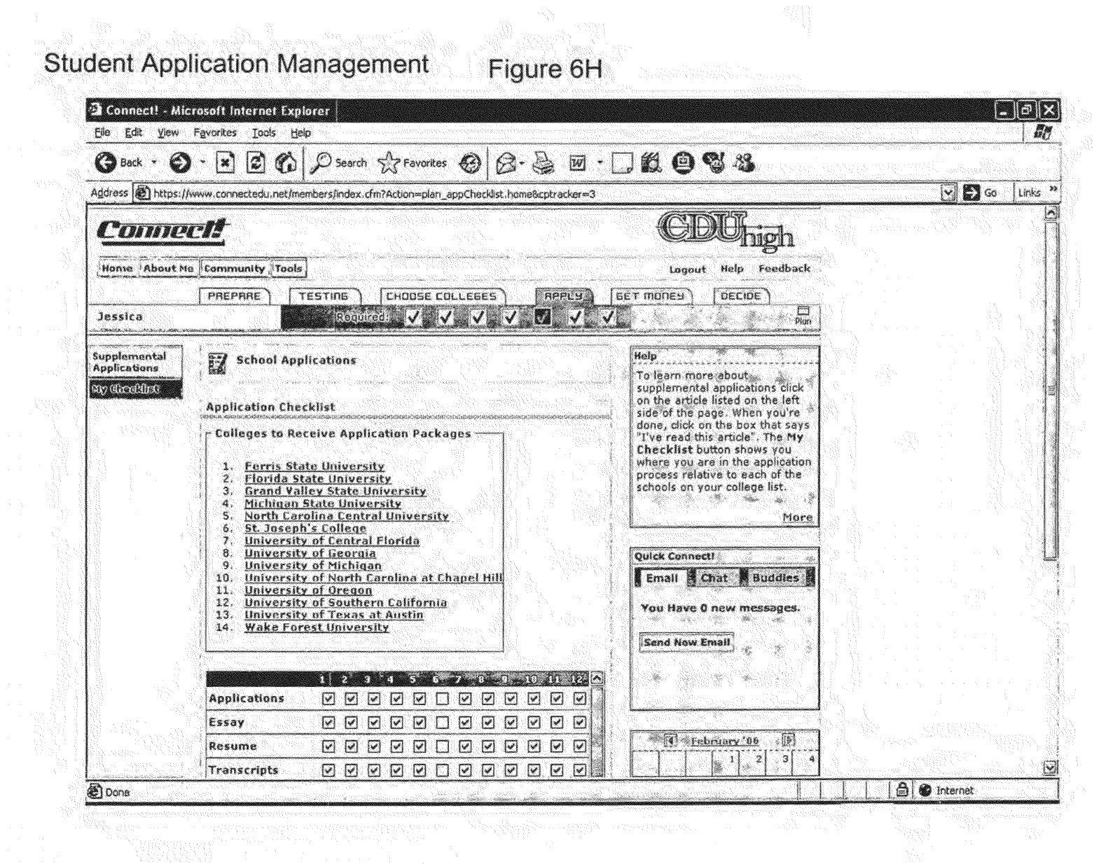

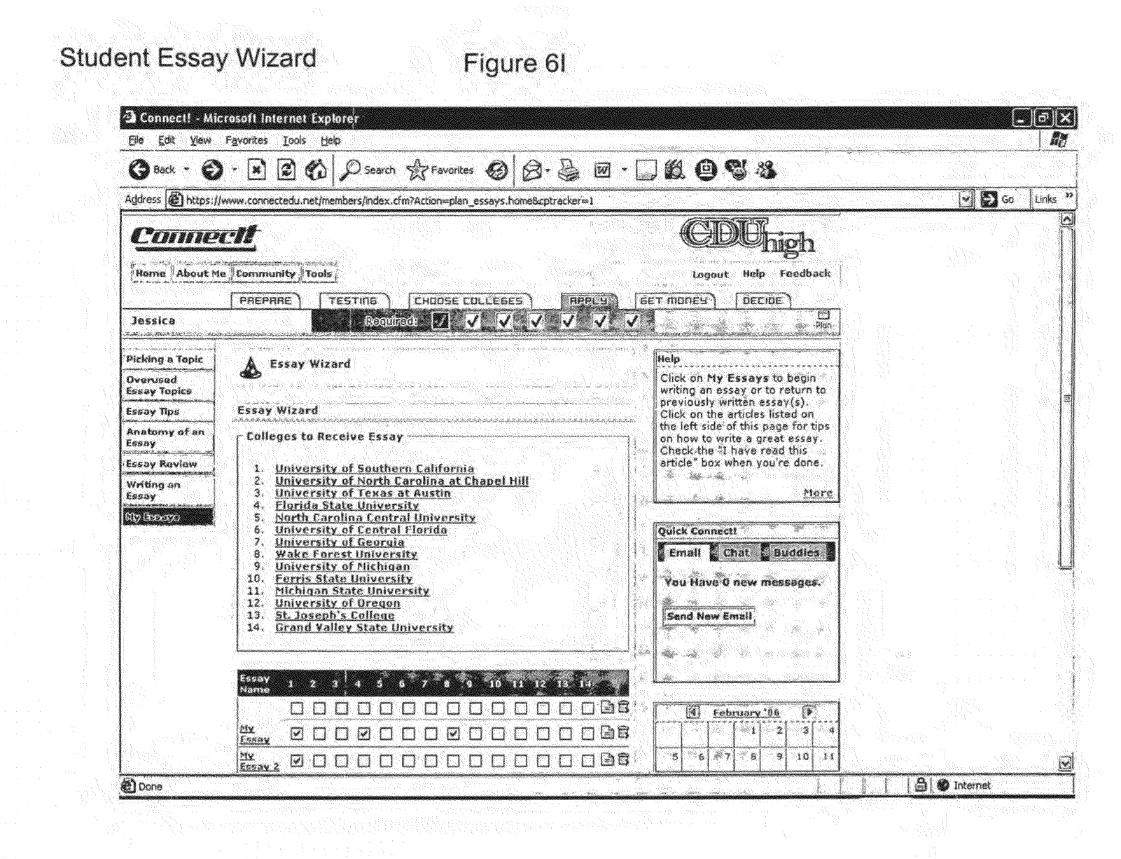

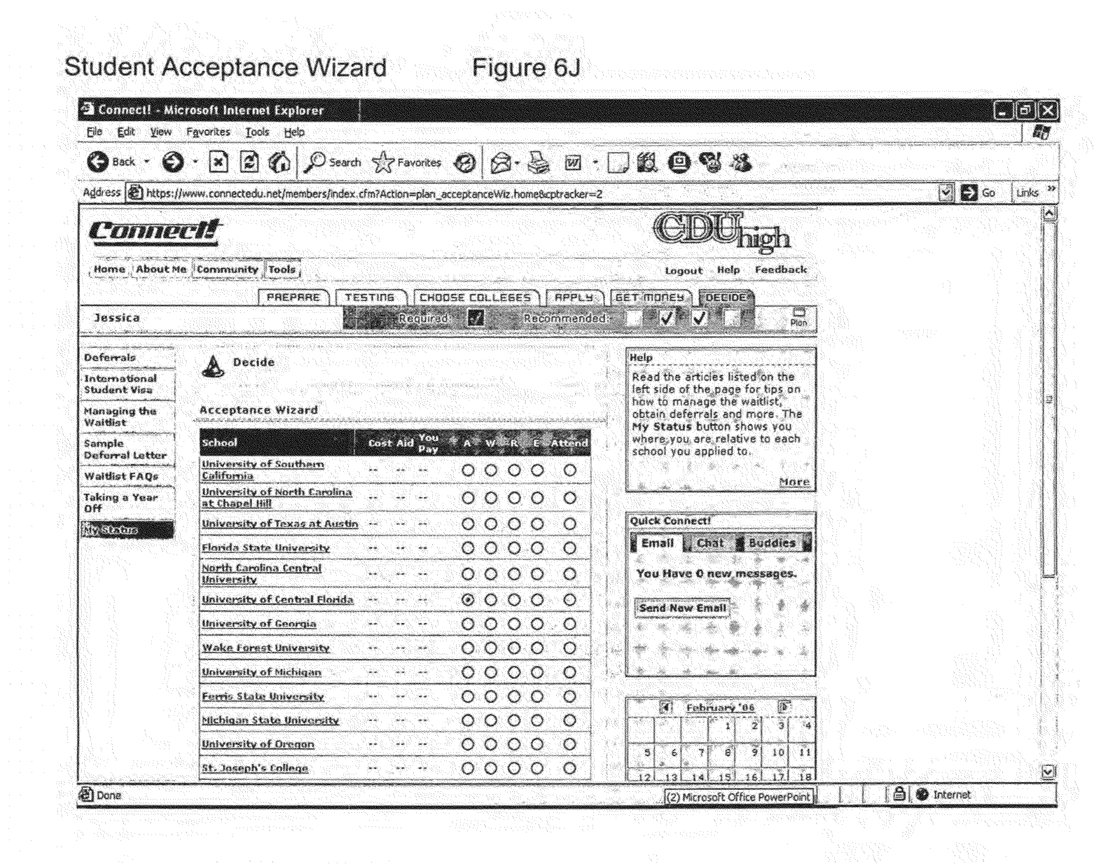

As discussed above, the ability of a user to generate a profile, such that it can be correlated, matched and compared with other profiles, simplifies the college selection process. Conversely, an academic institution's profile and targeted marketing can advantageously facilitate admissions decisions or an audit of a particular college's admit/reject demographics. However, although profile sorting and correlations are one aspect of the invention disclosed herein, the ability to streamline the application process via a college plan or application plan is also another aspect of the invention. In particular, the college plan is one resource that is available to a particular user using the software implementations disclosed herein. As is the case with all of the methods and systems disclosed herein, the college plan can be executed on a server as a program that is accessible via an application such as browser or as a stand-alone software implementation that can be ruin on a computer. Additionally details relating to the college plan (generally, educational institution application plan) are shown in FIG. 5A and FIG. 6A.

A representation of an interface portion 50 suitable for accessing a college plan as disclosed herein appears in FIG. 5A. Similarly, FIG. 5B depicts an exemplary home page architecture for integrating various aspects of the invention shown in FIG. 5A. A custom and personalized college plan can be created for all student users to guide them through each of the appropriate steps to successfully complete their college preparation, search, application and financial aid process. Each college plan is customized for the student based on academic, non-academic, financial and collegiate goals, as indicated in the user profile. The college plan connects each phase, step and task of a student's process providing each user with the guidance necessary to successfully complete the application process. Additionally, a progress tracker is typically included within the college plan interface that indicates which step the user is currently working on relative to either their process, or the process for the student user (or users) that they are actively managing.

The college plan is implemented using software that incorporates fixed and flexible logic and/or rules to create a customized experience for each applicant or user. The logic correlates each phase, step, task, resource, form and object, other user profiles and calendar year schemes to develop a customized college plan for each user. The methods disclosed herein correlate other user profiles and assigns them to track, monitor, interact with specific users throughout all aspects or individual aspects of their college plan and/or their experience with the implementations and modules disclosed herein.

The columns shown in FIG. 5A labeled Prepare 52, Test Prep 53, Choose Colleges 54, Apply 55, Get $ 56, and Decide 57 represent sub-processes within the college plan interface 50 for the larger collage application process. A graphical user interface screen, suitable for access by a web browser is shown with clickable tabs or icons in FIG. 5B. The interface screen 58 represents a starting point or home page by which a user of some of the systems and methods disclosed herein can start and manage the college application process. The clickable tabs shown on the interface screen, Prepare 52′, Testing 53′, Choose Colleges 54′, Apply 55 ′, Get Money 56′, and Decide 57′, access the resource folders depicted in FIG. 5A and discussed in more detail below. The resource folders allow a user to interact with other interface screens to perform tasks relevant to the college application process.

As shown in FIG. 5A, each of those columns is a resource folder that further subdivides each sub-process into specific tasks for the user to execute. The resource folders and associated tasks are arranged based on a calendar scheme that tracks the overall admission process. Dividing the complex college admission process into tasks reduces applicant anxiety while ensuring that the application process is completed, no opportunities are lost, and all necessary deadlines are met on or ahead of schedule.

According to one aspect of the invention, users receive access to a suite of resources on every topic associated with the college preparation, search, application and financial aid process. Each resource folder contains descriptions, instructions, recommendations, examples, student opinions, professional opinions and processes for each phase. Additionally, while users can view resources at any time, the methods disclosed herein are also “smart” enough, at least in part by virtue of hierarchical logic, to deliver the resources to each user when needed by that user. Thus, the resource folders, the data analysis techniques, college selection techniques and other aspects of the invention are all integrated with the college plan.

Still referring to FIG. 5A, the prepare resource folder 52 includes information on Savings Plans, Academic Requirements, NCAA Eligibility Requirements, Resume Creation, Scholarship Search, and a host of other topics. The Test Prep resource folder 53 includes information on the tests themselves, how they are administered, evaluated, etc., as well as resources for preparing for college. The Choose Colleges resource folder 54 includes information on campus visits, methods for identifying a student's preferences, the creation of a quality college list, and numerous other related topics. The Apply resource folder 55 includes information on the applications, how to request them, the anatomy of college applications, essay writing, admissions plans, submittal of test scores, and countless other topics. The Get Money resource folder 56 includes information on federal aid options, the process of applying for financial aid, scholarship options, evaluating financial awards, and countless other related topics. The Decide resource folder 57 includes information on acceptance letters, waitlist strategies, deferrals, the decision to attend and countless other related topics. Although a specific listing of resource folders is shown, the invention is not limited to a set number or a particular task grouping. The resonate folders, the data analysts techniques, college selection techniques and other aspects of the invention can integrate with the college plan.

In part, the college plan approach disclosed herein itemizes all process steps, their dependencies, and the cause-effect relationships for completing each step indicated in the college application process such that the process is manageable for the applicant. While at the same time reminders, alerts, action items are presented to a user and/or their parents and counselors as appropriate to make the process error free and subject to supervision. Additionally, given the integration of a user's profile and those of other objects and resources, the college plan is adapted for reducing redundancies and employing external data sources such as for example property values in the applicant's neighborhood to pre-populate the relevant sections of the financial aid form.

In addition, the financial aid specific methods can query the federally mandated aid levels to determine if the applicant should appeal their aid award. As a result, access to a college plan and the other aspects disclosed herein allows far a significant simplification and improvement in the college application process over the prior art. Additionally, details relating to the integration of the college plan with other aspects of the invention are described in the interface embodiments of FIGS. 6A-6J.

FIGS. 6A-6J illustrate an underlying design and layout for graphical user interfaces for different embodiments of the invention. However, since the format of given webpage can change over time without affecting the underlying data processing and software implementation, these figures are included to show how some embodiments can be integrated in one robust educational institution application tool without limiting the scope of the invention.

An exemplary page architecture 60 for accessing and managing portions of college plan suitable for running on an application server 16, 42 is shown in FIG. 6A. In particular, FIG. 6A shows links to various components of an exemplary college plan. Logo positions for various partner companies, such as loan, tutoring, or 529 plan providers can also be part of the interface screen's design. In addition, a calendar for automatically identifying reminders and deadlines in the application process are part of the design. Additional detail relating to an exemplary calendar view is discussed below with respect to FIGS. 6E and 6F. Typically, the college plan process tracker discussed above would also appear persistently or when a user accesses the page 60 from the server.

As shown in FIG. 6A, the process of applying to an academic institution can be divided into a schema of sub-processes. As shown in the figure, in one embodiment, these sub-process can include, but are not limited to Academic History, Area(s) of Study, Extracurricular History, Resume Wizard, College Preferences, Research Savings Plans, Research Scholarships, Improve College Readiness, Test Scores, Standardized Tests, Test Calendar Wizard, Research Schools, Initial College List, Narrow College List, College Visit Wizard, Application Deadlines Wizard, Institutional Scholarships, Essay Wizard, Recommendation Letter Wizard, Request Applications, Common Application, School Applications Supplemental Essays, Submit Applications, Financial History Interview, FAFSA, CSS, EFC Calculator, Award Review, Financial Aid Tips, Appealing Awards, Decide, Review Acceptances, Review Payment Options, and Thank Yous. Each of these tasks are presented to the user in an organized manner grouped by the categories shown in FIGS. 5A and 5B, in the order in which they should be considered as part of the application process.

From the student homepage used to access some of the aspects of the invention relating to the application process shown in FIG. 5B, a user of the college application system can access the choose colleges icon to perform research relating to particular academic institutions. Additional detail relating to the choose colleges is shown in the interface screen depicted in FIG. 6B. In particular, the interface screen depicted in FIG. 6B shows the ability to review individual college profiles based on geographic location and other factors. Once a user of the overall system has identified certain candidate academic institutions of interest, the individual schools can be compared using the interface screen depicted in FIG. 6C. The initial selection of schools that are best fit match for a particular student can be achieved using the approach described above with respect to FIGS. 3A-3C.

In turn, FIG. 6D depicts a webpage architecture for a given user's profile. While FIG. 6E shows an exemplary tool page architecture for performing data analysis and searching relative to the college application process and database objects. One of the tools that users of the system have access to is a calendar scheme that organized the application process as shown in FIG. 6F.

In another aspect, the invention provides users with a Financial Aid Form Completion Wizard that allows families to complete their Federal and institution specific financial aid forms electronically with less anxiety. The methods disclosed herein utilize form completion and process education functionality that integrates with external data sources and the object focused approach described herein. An exemplary interface screen for conducting a financial aid interview is shown in FIG. 6G. As shown, this process can be linked via the Get Money tab discussed above with respect to FIGS. 5A and 5B. In one embodiment, users have the ability to maintain their forms and re-apply year-to-year automatically using pre-existing and new profile data. Additionally, the methods disclosed herein offer the ability to integrate with federal, private and institutional lenders to provide families with a seamless borrowing process.

Another Financial Aid Form Completion Wizard embodiment includes an interactive dialogue format for users to experience a live answer and form completion process that integrates with the user's profile and college plan as opposed to a static branching form completion approach.

In addition, the methods disclosed herein provide Financial Aid Evaluation Wizards that allow users to input institution specific financial aid packages they have received. Once input, the user can compare the “equity”of the award based upon their academic and financial profile relative to the financial aid award history of the institution.

The methods disclosed herein also relate to a financial planning resource suite designed for financial advisors to use with their existing customers as well as a client acquisition tool. The Financial Advisor Platform utilizes the existing technology resources of federal and institution specific financial aid completion tools in addition to providing Financial Advisors with a tool to monitor and track client and agent activity.

As outlined above in FIGS. 5A and 5B, as part of the user interface, there is an Apply tab that directs the user to applications that facilitate the college application process. For example, FIG. 6H shows an interface screen for student application management. As shown, the application system disclosed herein tracks the degree to which each application for a given academic institution is complete. As college applications typically require a written essay, as a subset of the Apply folder discussed above with respect to FIG. 5A, an interface for preparing the essay is integrated in an embodiment of the overall system as shown in FIG. 6I. In addition, to tracking the completion status of essays for particular schools, the interface screen shown in FIG. 6I also provides tutorials and information for preparing an essay such as Picking a Topic, Overused Essay Topics, Essay Tips, Anatomy of an Essay, Essay Review, Writing an Essay, and My Essays. Finally, once the applications have been filed, the Decide interface screen shown in FIG. 6J, includes various applications and information to finalize the decision making process about a particular academic institution. For example, the interface screen shown in FIG. 6J also provides information about Deferrals, International Student Visa, Managing the Waitlist, Sample Deferral Letter, Waitlist FAQs, Taking a Year Off, and My Status.

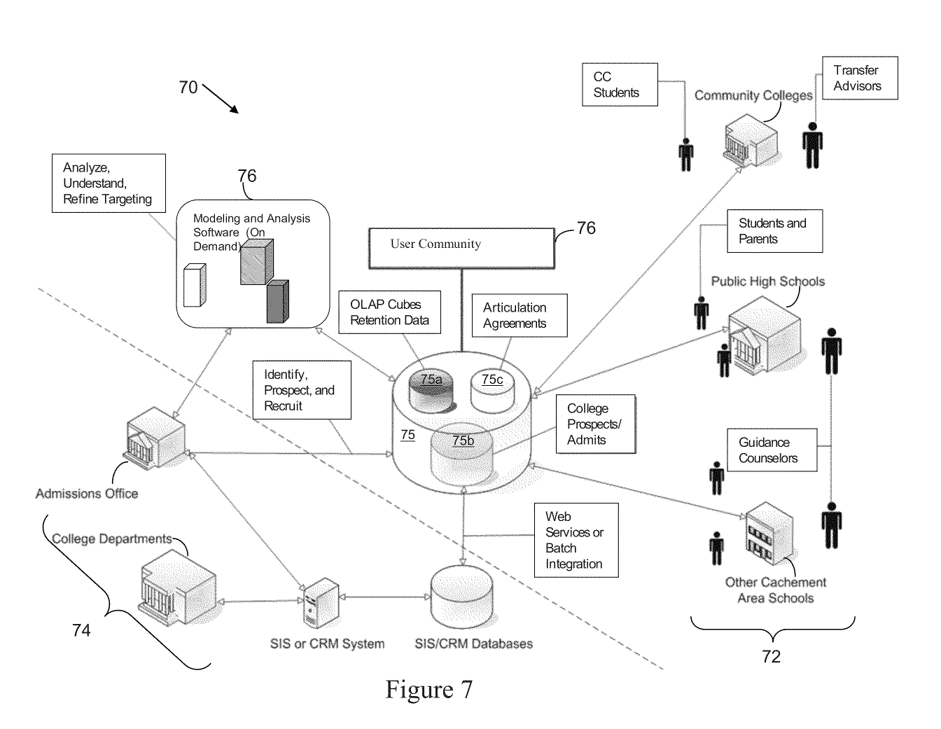

Another aspect of the invention relates to the admission and student recruitment process as implemented from the college, university or other academic institution perspective. Just as it is challenging for prospective applicants to find the right academic institutions and wade through the application process, it is equally challenging for academic institutions to find the right applicants. Drop out rates, student transfers, misdirected marketing all negatively impact admissions efficiency. Accordingly, one aspect of the application relates to a system by which the efficiency of the enrollment management process, i.e., the process of finding and recruiting the best fit applicant pool is improved. Additional details relating to this process are shown in the system overview depicted in FIG. 7.

For an admissions officer, the problem is to find the right students who will not only matriculate to their school, but also will succeed and not leave before graduation, either through transferring or dropping out. Therefore, the value proposition associated with implementing the enrollment management techniques disclosed herein is to foster a more efficient marketplace with respect to attracting the best pool of applicants from the perspective of the college. This is achieved by offering class positions to applicants having profiles that are correlated with at least one of academic success, post-graduation success, substantially reduced likelihood of dropping out, and substantially reduced likelihood of transferring.

Colleges and universities require measurable and cost-effective methods of interacting with and attracting students as well as retaining them once they arrive on campus. Because today's college-bound student is largely unresponsive to direct mail and other traditional marketing efforts, college admissions officers require systems and methods to help them identify and directly communicate with targeted students. An exemplary system 70 for enrollment management is depicted in FIG. 7. Using the system 70, colleges and universities are able to develop relationships over time with college bound students and their families. This allows colleges to customize recruitment strategies on a per student basis. In addition, by using historical data informed by drop out rate, transfer rate, future employment, and other statistics, a working model can be assembled to determine the best candidates for admission to a particular institution. In one embodiment, the system 70 is implemented using a client-server approach similar to that discussed above with respect to FIG. 1. The system facilitates enrollment analytics in the form of collecting sufficient pre- and post-application success information, which can then be used by admissions professionals to admit the right students, i.e. students that will succeed at this institution.

As shown in right side of FIG. 7, a group of applicant generating entities 72 is shown. Specifically, high schools, other cachement area schools, and community colleges are shown as sources of feeder applicants that enter the enrollment management system for ultimate placement in a four-year college or university. The students that are seeking admission, their parents, the guidance counselors, and the transfer advisors are all involved in locating the best fit college. The techniques and systems discussed above in more detail relate to finding the best school for a particular student. In the left side of FIG. 7, a collection 74 of the colleges, universities and their associated admissions officers are shown as handling the reciprocal problem of finding the best applicant. As shown, the collection of academic intuitions 74 can use SIS and/or CRM Systems with accompanying databases to track and store applicant data for subsequent analysis. Student Information Systems (SIS)/Customer Relationship Management (CRM) database can be used to track every interaction with a potential student or parent right through the life-cycle of those interactions from applicant to matriculating student. To the extent that information is exchanged between an academic institution, the system can relate school performance information with the admit/deny prospect information.

The automated data analysis and information disseminating system 75 that ties together the collection of academic institutions 74 and the group 72 of applicant generating entities also interacts with a user community 76. This user community can include all of those individuals, institutions, and entities that subscribe or otherwise have access to the data analysis and information disseminating system 75.

In one embodiment, the data analysis system 75 includes one or more databases and data analysis modules adapted for storing, retrieving, comparing, and correlating data. As shown, the data analysis system 75 can process retention data 75a, college prospect applicant data and admission data 75b, and articulation agreement data 75c.

The retention data can be in the form of OLAP cubes; however, other suitable data structures can be used as appropriate for any of the data described herein, without limitation. Retention data is a data asset that is built up over time that identifies profiles, criteria, and other parameters relating to prospects, (prospective applicants), and admits, (admitted candidates), and what constitutes a successful vs. unsuccessful applicant. Retention data focuses on students that do not transfer or drop out. For example, an applicant that goes on to graduate and does well academically once admitted, may be considered a successful candidate and serve as the basis for establishing an admission profile indicative of success. College prospect applicant data and admission data relates to the individual data associated with those that apply and those that are ultimately offered admission. Articulation agreements are agreements between the community college and an academic institution (4-year) that define how courses are to be transferred if a prospective applicant wishes to transfer from the community college to a 4-year institution. Articulation agreement data is used to provide automated information to prospective applicants such that they are informed about how their courses will transfer when seeking admission to a 4-year institution. The system 70 can load course catalog information on behalf of both two year and four-year institutions, and allow each to maintain a neutral store of articulation agreement information that is browseable to community college students.

The system allows users, such as admissions officers, to identify, prospect, and recruit applicants that are good fit from the school perspective. When integrated with the application process described above with respect to a portion of the user community, the system can also facilitate a paperless enrollment management process. This represents a significant advantage over the rooms of paper that characterize many admission offices. The system 70 allows a user, such as an admission officer working for school ABC to perform a search based on criteria that yields a list of students, typically on an anonymous basis grouped by scores, GPA, location, and other factors. If the user has already expressed an interest in school ABC, the system can be configured such that this advance interest removes the anonymity and allows the admission officer at school ABC to open a dialog or send direct marketing materials to the student.

Thus, the system 70 supports active prospecting and student selection for use by academic institution admissions officers to locate and build relationships with certain students. The methods and systems described herein also allow colleges to search through an applicant pool and find admission candidates using an internal view of what a successful student is, find those students by region or characteristic, and electronically work with them to improve enrollment efficiency. In one embodiment, some of this system 70 functionality is implemented using Modeling and Analysis Software 76 that can be available on an “on demand” basis to facilitate analysis, understanding, and refined targeting of applicants for the purpose of enrollment management.

As shown in FIG. 7, the goal is to create an efficient market from the academic institution admission office perspective. Another feature of the system 70 is to provide electronic transcript handling and letter of recommendation handling. At present, these features are expensive to manage using a paper based approach. Integration with systems discussed above with respect to FIGS. 5A-6J further streamlines and automates the document management associated with college enrollment management and the application process. The methods disclosed herein provides users with an eTranscript function for seamless completion of college applications and transfer of academic information in a secure, encrypted environment. Users receive logs of when transcripts were sent and delivered to ensure information is not lost or misplaced by admission offices. Admission offices benefit with the reduction in paper.

One aspect of the invention uses historical data to inform the admit, deny, or hold decision making process of an admissions officer for an academic institution. Given a pool of data identifying those applicants that the academic institution has admitted, conclusions and correlations can be drawn based on how those applicants succeeded or failed at the institution. In one embodiment, the data analysis uses OLAP cubes to describe the attributes of a successful applicants such as where they come from, what are the key factors that make them successful to model an admissions profile.

As discussed above, the system 70 provides active and passive prospecting tools such that the identity of a student is not revealed unless a “knock-knock” process is followed by the admissions officer (blind inquiry of student requesting further disclosure). Once given permission, that officer may view the student's entire profile and begin the process of building a relationship online and/or offline.

Once a student has decided to apply to a particular academic institution, they can use the new tools available under the Apply tab to start the process. If an academic institution's admissions office has already been in contact with the student, and the student has given prior permission, the academic institution admissions officer will be able to view courses, grades, GPA, and scores on that student. These items in the students online record in the system 70 can be marked draft for review only and the items supplied by the student and by the school will be clearly identified as such. No transmission of transcript data occurs without the student and guidance counselor taking discreet actions and providing approval.

Once the student has decided to send their transcript to an academic institution and indicates this has occurred as pan of the college plan integrated in the aspects of the invention discussed above, a workflow starts which alerts the school guidance counselor/transfer advisor by email and provides them with several review/decision steps. The counselor reviews and approves the request, verities the transcript contents and vouches for its accuracy. This workflow mimics the current activity that occurs at most schools and provides a useful cheek/balance against inaccuracy and impetuous behavior on the part of the student.

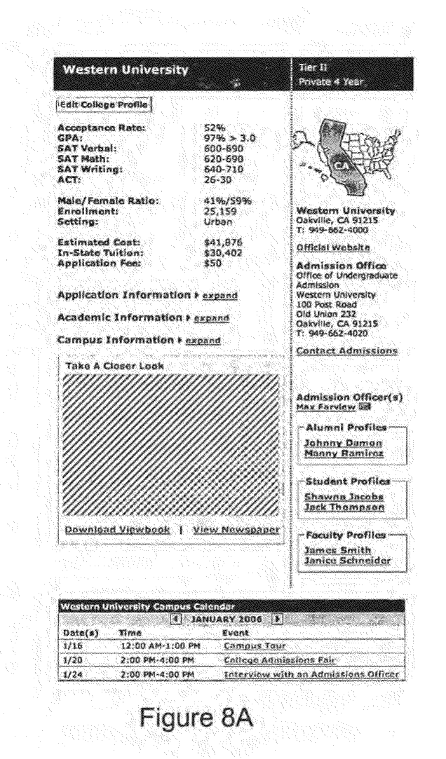

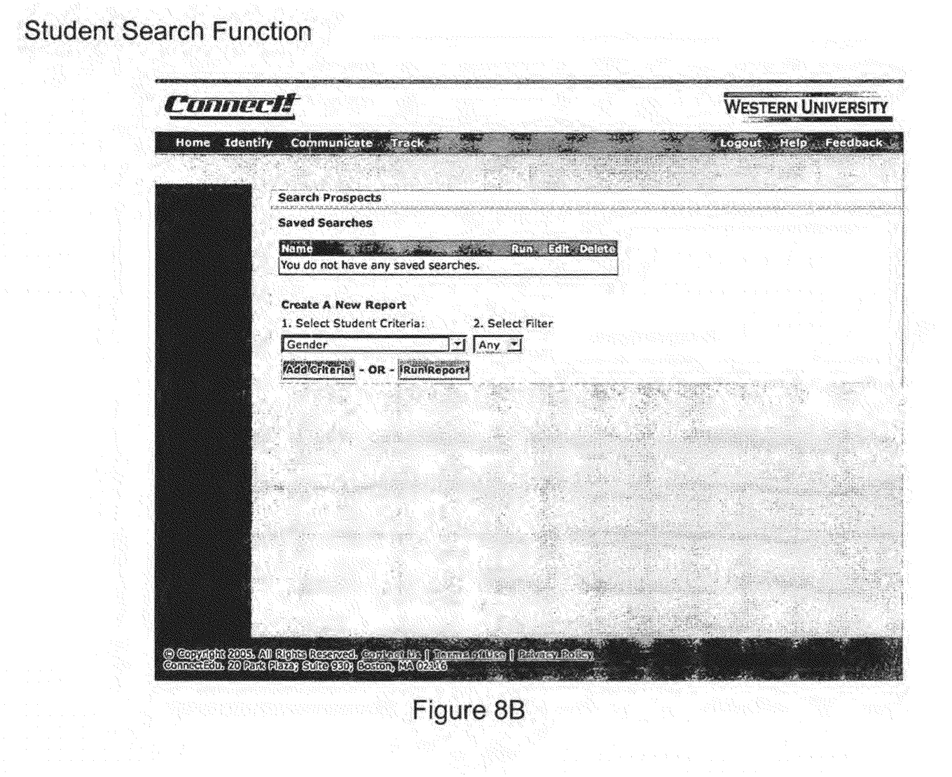

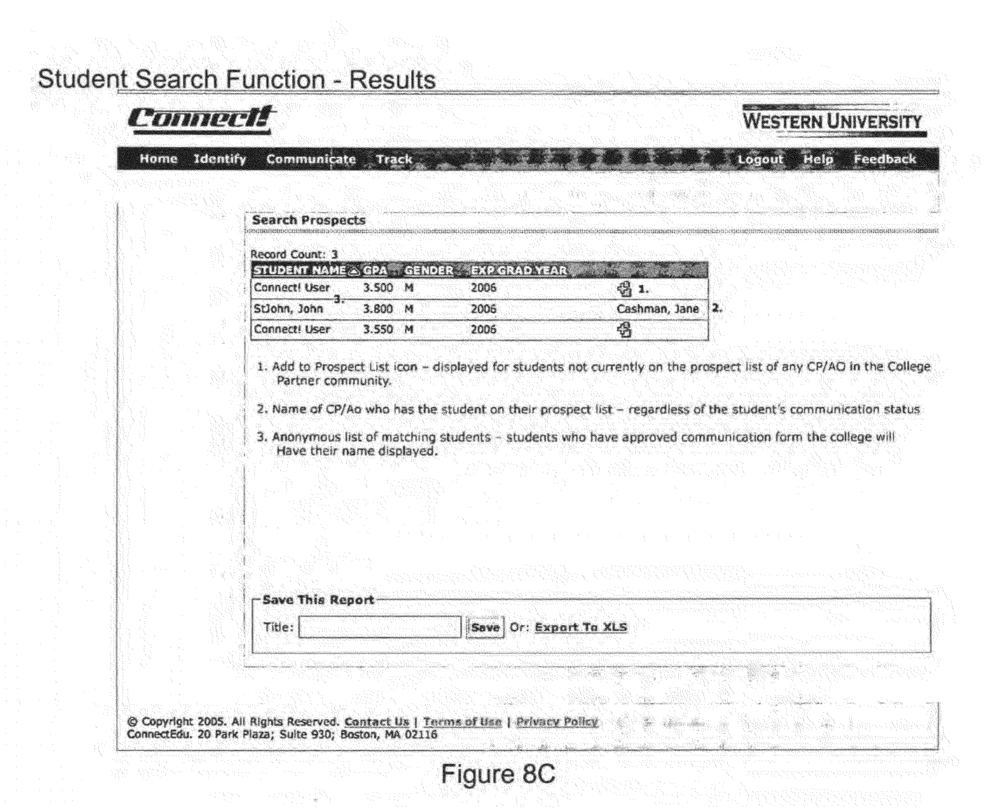

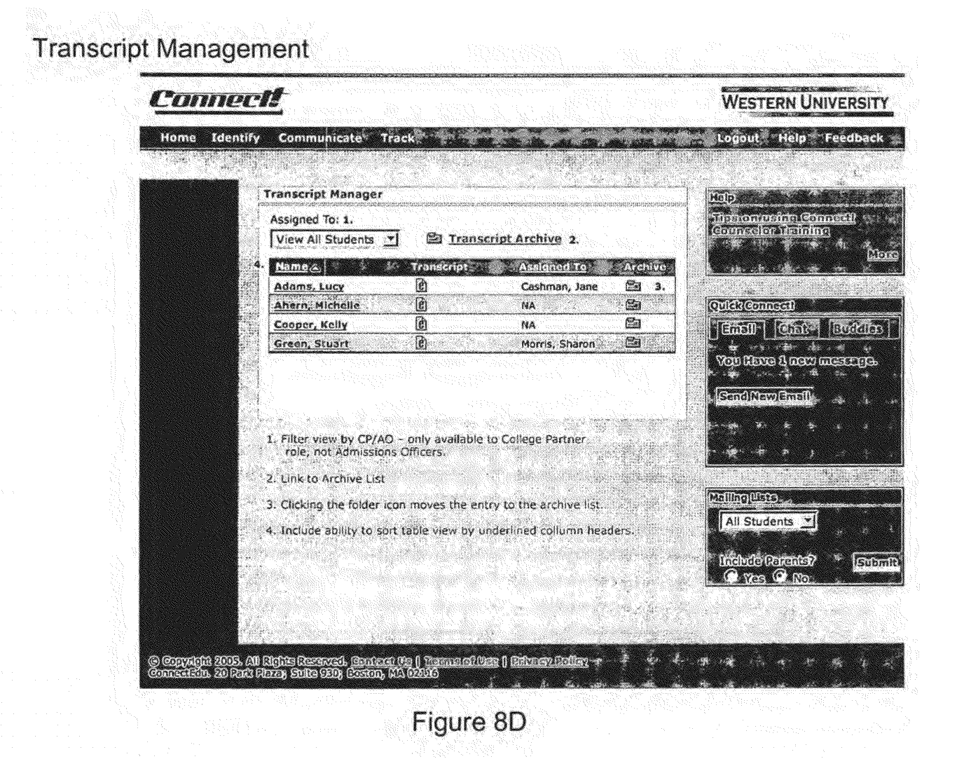

With respect to the overall enrollment management system 70, there are various interface screens that can be used to connect the enrollment management system with the user community. FIGS. 8A-8D show some exemplary interface screens that can be integrated with the system 70.

As shown in FIG. 8A, the system 70 can be used to provide college profile screens that contained information that may be of interest to a prospective applicant. These profiles can be targeted for particular applicants in response to their profile data. When an admission officer is interacting with a prospective applicant, the college profile screen can be used to convey information about the school. This type of college profile can be integrated as a search result in the system described above with respect to FIGS. 5A and 5B.

FIG. 8B shows an interface screen that an admissions officer may use to interact with the system 70 when attempting to locate one or more prospective applicants of interest. In response to the questions asked, a search query is assembled, and a list of relevant applicants that match some profile are located. A list of exemplary results is shown in FIG. 8C. As shown, some users are anonymous as they have not indicated an interest in the school that the admission officer represents. Additionally, for students that are applying to a particular school using the system 70 or contemplating applying to the school, the admissions officer may have access to their transcripts to facilitate a substantially paperless application process as shown in FIG. 8D. The system 70 facilitates enrollment management and is suitable for integration with college application software to ease the application process from the applicant perspective and to improve the efficiency by which students are admitted from the admissions office perspective.

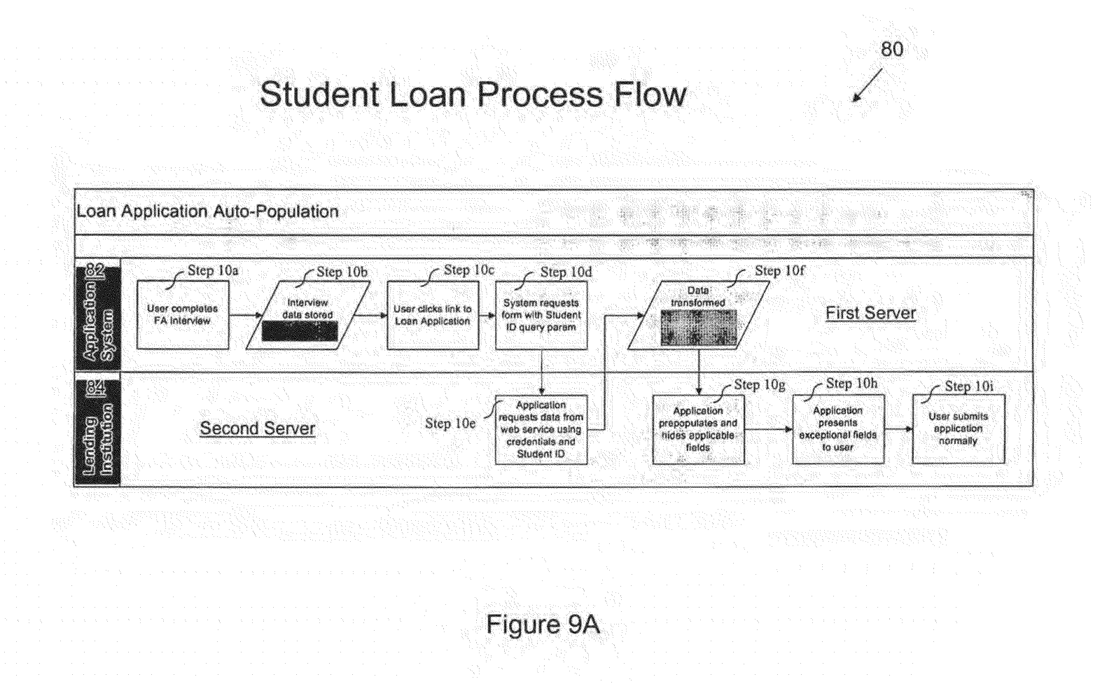

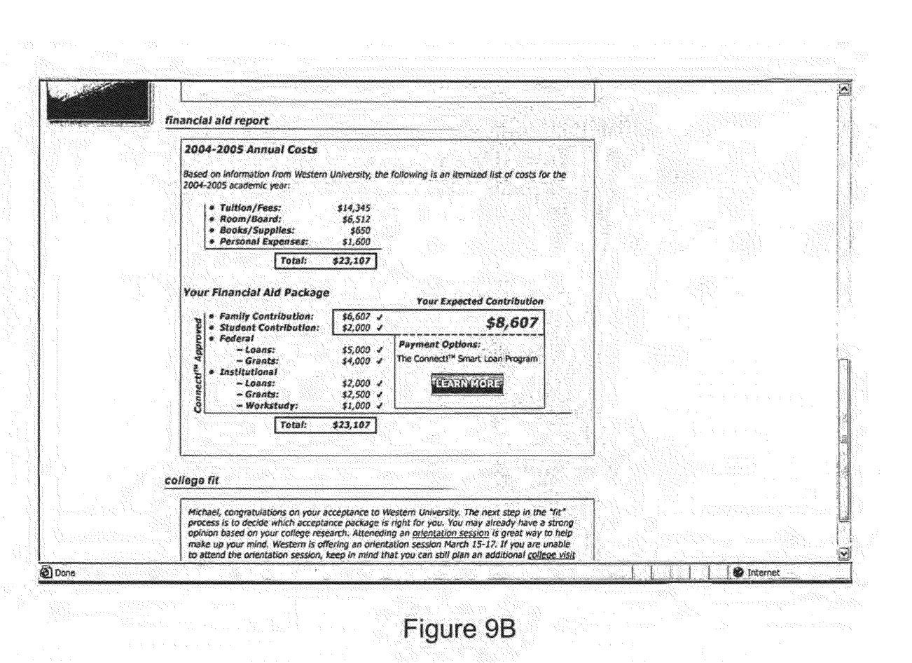

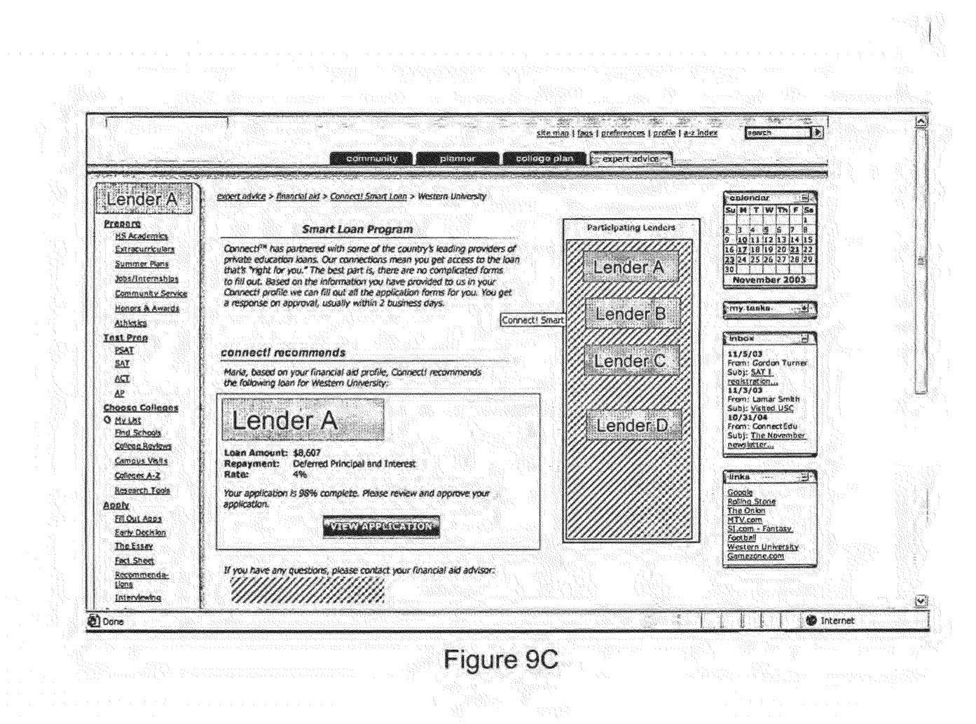

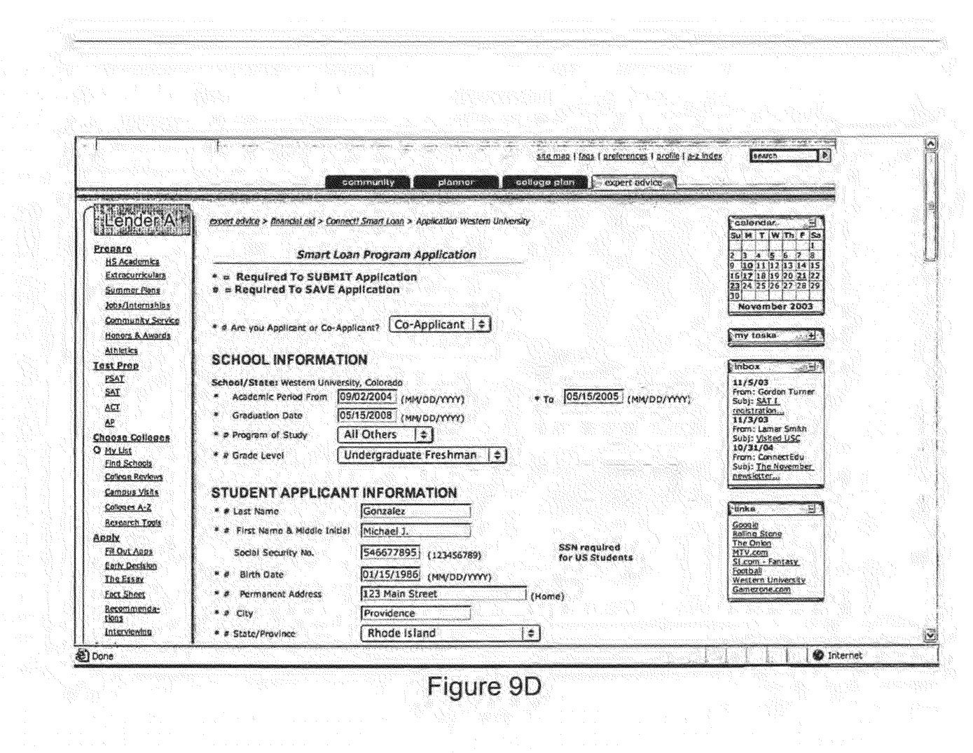

The invention also relates to a distribution strategy that insures the creation of a highly qualified community of students. As discussed above, this facilitates directing targeted advertising to students for particular products and services. Since the costs of financing a college education continue to increase, information about the financial options available is of particular interest to students and the loan providers. In particular, lending institutions and students benefit from the targeted advertising described herein because it helps students get funding and it gives lending institutions a competitive advantage over non-participating lenders. As such, the techniques disclosed herein improve student loan volume while providing students with a meaningful college search, application and financial aid process. In addition, the techniques disclosed herein furthering the lender's brand with college bound students and the parents of college bound students. Also, partner lending institutions can contract to receive data regarding where and when the student is going to school, subject to the student's agreeing to sharing this data. Additional details describing a student's interaction with a lending institution according to an aspect of the invention are discussed in more detail with respect to FIGS. 9A-9D.

FIGS. 9A-9D demonstrate a process workflow and exemplary graphic interface examples for interacting with a student loan provider based on the demographic, financial aid, and expected financial contribution of a student following the completion of the college financial aid process. In particular, an exemplary method 80 depicting the interaction between an application system 82 and a lending institution 84 according to an aspect of the invention is shown in FIG. 9A. The system 82 can include a stand-alone software application or be integrated within an overall college application system such those discussed above.

Typically, the system 82 is running on a first server. In turn, the lending institution has an associated second server that contains its student loan forms as part of an automated software form system that can be populated, at least in part, using student data from the first server. Initially, a user of the system 82 completes the Financial Aid (FA) Interview (Step 10a). This financial aid interview can be substantially similar to the process illustrated in FIG. 6G. However, other financial aid interview schemes can be used in various embodiments. Once the interview is complete, the data is stored (Step 10b). The interview data can be stored in any suitable format and language. In one embodiment, interview data is stored in a text format such as the Extensible Markup Language (XML) format. After the interview is complete and the data has been stored, the user will start the loan application process (Step 10c). In one embodiment, the user of the system 82 accesses an automated loan application via link, icon, or other GUI interface. At this point, the student begins to interact with the second server associated with the lending institution.

In turn, as the application process varies with different lending institutions, the system 82 requests a student loan application form from the lending institution 84 using one or more Student ID query parameters (Step 10d). The student ID query parameters can include, but are not limited to student information, a token corresponding to a student ID record and certificates. From the lending institution 84 side of the interaction, the automated student loan application requests data from web services associated with the lending institution 84 using credentials and Student ID information (Step 10e). The credentials can include, but are not limited to lender certificates to indicate that they are a verified server, security tokens, and other web service identifiers. Thus, once the second server receives student identifier data, it communicates with the first server, indicating that it is a verified computer that can receive student data to populate its student loan forms. An encrypted channel between lender server and college application server is typically instanced at this point. The data that is obtained from the lending institution is then transformed and delivered to the automated student loan application (Step 10f). In one embodiment, the data from the lending institution is transformed using Extensible Stylesheet Language Transformations (XSLT), which is a language suitable for transforming XML documents into other XML documents and the transformed data is delivered to the loan application in XML format.

Once the transformed data has been delivered in a useable format to the server associated with lender, the automated student loan application form pre-populates the relevant data and hides any applicable fields (Step 10g). If any exceptional fields exist, the automated application presents them to the user of the system 82 (Step 10h). Exceptional fields are those that require additional information to populate the form other than the data provided by the first server. Examples of exceptional fields include, but are not limited to whether the student filed for bankruptcy, defaulted on a loan, and the number of years of loan repayment. After these steps are complete, a user of the system 82 submits the student loan application (Step 10i). At this point, a loan officer will typically contact to the student by mail if the loan is approved, rejected, or if more information is needed.

FIGS. 9B-9D show- graphic user interfaces suitable for implementing an automated student loan application process. As shown, the student loan process can be integrated within an application management system as described with respect to FIGS. 5A-6J. As described with respect to FIGS. 9A and 6G, after a financial aid interview has been completed, results are displayed to the user as shown in FIG. 9B. The “learn more” link shown in the figure can be configured to provide a student user with additional information or initiate an automated student loan application process as described with respect to FIG. 9A. FIG. 9C shows the next step in the process. As shown, a smart loan program is depicted which corresponds to an embodiment of an automated student loan application process according to an embodiment of the invention. As described above with respect to other aspects of the invention, a branching logical hierarchy can be used to streamline the population of an automated student loan form to save time and reduce mistakes.

FIG. 9C shows a student loan application interface associated with a particular sending institution, Lender A. Other lenders, such as Lenders B-D would also have individual interfaces that can draw on common user data to populate each institutions' loan form as discussed above with respect to FIG. 9A. An exemplary automated student loan form is shown as part of the interface depicted in FIG. 9D. In some embodiments, only certain lenders that are partnered with a service provider are displayed as branded partners on the interface shown in FIGS. 9C and 9D. By drawing on a common pool of student data, a student can apply for quotes and/or loans from multiple lending institutions without re-typing the same information for each institution. In addition, by integrating the lending component with the application process, a student user is able to apply to college, determine their financial need, and satisfy that need as part of one overall system using the techniques and systems disclosed herein.

Applicants have determined that their are the two primary student loan marketing approaches in the consumer marketplace (Direct-to-Consumer Mail/Direct-to-Consumer Web Based Campaigns) as seed as analysis of the prevailing student loan marketing approach in the employer marketplace (Affinity Marketing).

Many traditional loan-marketing approaches employ a consumer pull approach. By definition, this approach precludes the ability to monitor lead qualification actively and eliminates the possibility of dynamic customer service intervention. As a result, the lead that is finally targeted in the process must ultimately complete a loan application that includes over one hundred steps.

Unfortunately, this process leads to both enormous waste as well as customer confusion. The methods discussed above with respect to FIGS. 9A-9D enable the targeting of users that are qualified from the outset. This follows because they are completing a comprehensive college search, application and financial aid process, and will automatically satisfy nearly one hundred of the loan application steps along the way (allowing for the pre-population of data fields for the loan application as shown, in part, by FIG. 9D). Thus, a demographic set of quality leads is immediately available to a service provider by using some of the methods of the invention.

Additional modules, implementations, and embodiments suitable for integration with other aspects of the invention are discussed in more detail below. To further illustrate the scope of the present invention, the following additional embodiments and functionalities are provided, but the present invention is not to be construed as being limited only thereto. All of these additional aspects of the invention are suitable for integration with the methods discussed above or for stand alone deployment via a server, a client, a web browser, a compute program or other suitable mechanism.

The invention also incorporates a college profile comparison method that allows user to compare schools across the same criteria, side-by-side. Users are able to create a customized report, incorporating data elements that are important to classes of students (i.e. average student indebtedness, SAT scores, Hispanic student population, etc.) as well as to a specific student (i.e. distance from home, relative to school size requirements, relative to student's SAT scores, etc.)

One implementation of the college plan disclosed herein assigns a small team of education and financial aid professionals that are responsible for guiding all students through the completion of their college plan. Users are routinely prompted by their dedicated education professionals within the mechanisms available through the application server and software as well as over the phone. Users also have the ability to proactively contact their dedicated professional through the software implementation of the methods or by phone via a toll free number. Assignment of a small team to each student ensures redundancy as well as targeted expertise for each stage of the process. In addition, the object profile matching techniques disclosed herein can also be used to match counselor profiles with students profiles to ensure goodness of fit for varying stages in the college plan. In other words, the best counselor to assist a student with the college application is not necessarily the best counselor to assist the student with the completion of the financial aid application.

The college profile aspect of the invention also provide users with personalized assessments relative to each of the 3,700 institutions. The college profile related methods compare the academic, financial and preferences profile of each individual student. These assessments serve to inform students during the college search, admissions and financial aid process relative to their profile, courses required, financing issues, desired outcomes and the best steps to achieve desired results.

Another aspect of the invention incorporates a college tracker that provides users with the ability to track key college visit, admission and financial aid dates and deadlines for each of the colleges/universities that are of interest. Users receive reminders as deadlines approach if they have not completed the required task.

Users can also access a personal calendar to manage dates, deadlines, tasks and community events throughout then college search, application and financial aid process. Users' calendars integrate with all dates and deadlines associated with specific college/university events, application or financial aid deadlines as well as the relational community events so that users can seamlessly monitor their college plan calendar.

The methods disclosed herein provides student users with a Letter of Recommendation Wizard that allows them to seamlessly coordinate their Letter of Recommendation authors and provide them with the information they need to successfully draft an appropriate letter of recommendation.

The methods disclosed herein provides users with a College Visit Planning and Evaluation Wizard that ensure that students conduct successful and complete campus visits as well as providing the tolls necessary to chronicle initial thoughts with respect to a targeted institution and rank institutions according to their criteria and reactions.

The methods disclosed herein provides sponsors with a Business Process Outsourcing solution designed to maximize scholarship program utilization, streamline the application and evaluation process, simplify notification efforts and save sponsors meaningful administrative expenses.

Another embodiment provides each parent user with their own homepage and set of resources and tools to monitor and guide their son/daughter as well as to facilitate parent-to-parent and parent-to-professional interactions. Each parent site is designed to speak to the parent and provides them with access to the resources that they require, as a parent, to be supportive of their child.

In addition, another embodiment of the invention provides methods for seamlessly coordinating with an employer's employee verification and payroll management databases. This coordination allows employees to register for 529 plans, indicate allocation/savings amounts, seamlessly segment indicated savings amounts from pre-tax paychecks while monitoring fund and savings activity.

The methods disclosed herein introduce the only on-line, seamless scholarship/college application/financial aid application object technology, that enable pre-populated applications based on a user's profile and ability to meet the selection criteria of the scholarship, college or financial aid application. In addition to its proprietary promotional technique, the methods disclosed hereto also provides for proprietary technology that facilitates the evaluation of applicants against an established criteria as well as comparing against historical evaluations of similarly characterized applicants. The methods disclosed herein also provides on-line notifications, applicant tracking, applicant record keeping, and on-going monitoring/management of applicants.

Another embodiment provides the functionality for students and counselors to have their own personal calendars for managing dates, deadlines, tasks and counselor office events/activities. As a result, users' calendars integrate with all dates and deadlines associated with specific college/university events, application or financial aid deadlines as well as school community events so that users can seamlessly monitor their tasks.

The processes for streamlining the application process integrates with student management, tracking, enrollment and transcript management systems to create electronic transcripts and student profiles as well as to indicate status of a user for comparison against other users/historical users, or to inform positively correlated user characteristics to calendar year or enrollment.

As discussed above, the process of applying to an educational system can be subdivided into a variety of sub-processes integrated with a college plan. The choice of sub-process in combination with delivering and calendaring tasks relating to the overall application process and sub-process simplifies the application process. In addition, it makes all of the relevant information directly available to the application while offering the data analysis and searching tools identified above. Some of the exemplary sub-processes that comprises the application process can, include but are not limited to some of the following: prepare to apply, academic information, extracurricular information, resume wizard, research financial need and aid options, augment readiness, college application essay wizard, recommendations, selection wizard, letter wizard, institutional money, request applications, test prep, test schedule/prep wizard, choose colleges, preferences, research schools, college list, visit schools, visit planner wizard, application and financial aid deadline wizard, narrow list of schools, apply, common application, school application, supplemental essays, submit checklist, get money, scholarship forms, tax forms, financial data, FAFSA, CSS/Profile, school forms, submit checklist, decide, review acceptances, review FA Packages, file Appeal regarding financial aid, review payment options, final decision, notifications, thank you letters, and attend orientation.

Embodiments of the invention may be commercially exploited in numerous ways. Specifically, employers may pay to utilize the methods disclosed herein to provide their employees and employee's dependents with the technology and resources required to effectively and efficiently navigate the graduate school, adult learner or undergraduate admission and financial aid processes. Additionally, the tools and methods disclosed herein can be sold to various partner companies to provide value added products and services to users while dramatically lowering customer acquisition costs for the relevant partners.

The invention relates to methods for simplifying the process of applying for a position with an entity. Generally, throughout the disclosure, the principle entity of interest includes, but is not limited to an educational institution or financial institution such as a college, a graduate school, a high school, a student loan provider, and a 529-plan provider. However, the scope of the invention and the appended claims can be extended to cover other application processes such as, for example, the insurance application process, the job application process, application for military service, or other application processes that represent a particular demographic of applicants.

The foregoing description of the various embodiments of the invention is provided to enable any person skilled in the art to make and use the invention and its embodiments. Various modifications to these embodiments are possible, and the generic principles presented herein may be applied to other embodiments as well.

It will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the invention.

Moreover, the processes associated with some of the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

Software of the server and other modules herein may be implemented in various languages, such as, for example, ColdFusion, ASP, ASP.NET, SQL, PL-SQL, T-SQL, DTS, HTML, DHTML, XML, ADO, JavaScript, JSP, and C#. In addition, software at the application server may be added or updated to support additional device platforms.

A “computer” or “computer system” may be, for example, a wireless or wireline variety of a microcomputer, minicomputer, laptop, personal data assistant (PDA), wireless e-mail device (e.g., BlackBerry), cellular phone, pager, processor, or any other programmable device, which devices may be capable of configuration for transmitting and receiving data over a network. Computer devices disclosed herein can include data buses, as well as memory for storing certain software applications used in obtaining, processing and communicating data. It can be appreciated that such memory can be internal or external. The memory can also include any means for storing software, including a hard disk, an optical disk, floppy disk, ROM (read only memory), RAM (random access memory), PROM (programmable ROM), EEPROM (electrically erasable PROM), and other computer-readable media.

In some embodiments, the data processing device may implement the functionality of the methods of the invention as software on a general purpose computer. In addition, such a program may set aside portions of a computer's random access memory to provide control logic that affects the hierarchical multivariate analysis, data preprocessing and the operations with and on the measured interference signals. In such an embodiment, the program is written in any one of a number of high-level languages, such as FORTRAN, PASCAL, DELPHI, C, C++, C#, VB.NET, or BASIC. Furthermore, in various embodiments the program is written in a script, macro, or functionality embedded in commercially available software, such as MATLAB or VISUAL BASIC. Additionally, the software in one embodiment is implemented in an assembly language directed to a microprocessor resident on a computer. The software may be embedded on an article of manufacture including, but not limited to, “computer-readable program means” such as a floppy disk, a hard disk, a downloadable file, an optical disk, a magnetic tape, a PROM, an EPROM, or CD-ROM.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

1. A computer-based method comprising:
providing a graphical user interface;
dividing the educational institution application process into a plurality of sub-processes using one or more computing devices;
arranging a portion of the plurality of sub-processes in response to a calendar scheme;
collecting profile data in response to a plurality of queries presented using the graphical user interface, the queries selectively presented in response to a branching logical hierarchy; and
generating a report in response to the profile data.

2. The method of claim 1, wherein the report is indicative of a trend of interest to the educational institution.

3. The method of claim 1, wherein the report indicates an action item the user must satisfy to advance an aspect of the educational institution application process.

4. The method of claim 1, further comprising the step of alerting the user to critical milestones.

5. The method of claim 1, wherein the method provides access to vendor services in response to a user inquiry.

6. The method of claim 1, further comprising the step of delivering targeted content to the user in response to user profile data.

7. The method of claim 1, further comprising the steps of screening users and restricting user access to a class of users defined by a relationship to participating partner firms.

8. The method of claim 1, wherein the calendar scheme is defined at least in part by the deadlines associated with a college admission process.

9. The method of claim 1, wherein the users are interconnected using a relational network, the relational network providing guidance for the application process.

10. The method of claim 1, wherein the report is a financial aid application form.

11. The method of claim 1 wherein the report is selected from the group consisting of a scholarship application; a 529 application form; a list of potential colleges, and a college application plan.

12.-32. (canceled)
